(19) United States
(12) Patent Application Publication
(10) Pub. No.: US 2017/0052826 A1
(43) Pub. Date: Feb. 23, 2017

(54) RESOURCE MANAGEMENT DEVICE AND RESOURCE MANAGEMENT METHOD

(71) Applicant: FUJITSU LIMITED, Kawasaki-shi (JP)

(72) Inventors: Kazuaki Sasaki, Yokohama (JP); Kiyoshi KOUGE, Kuwana (JP); Daigo Iwatsuki, Nagoya (JP); Yoshikazu Oda, Gifu (JP)

(73) Assignee: FUJITSU LIMITED, Kawasaki-shi (JP)

(21) Appl. No.: 15/211,054

(22) Filed: Jul. 15, 2016

(30) Foreign Application Priority Data
Aug. 21, 2015 (JP) 2015-163971

(51) Int. Cl. G06F 9/50

(52) U.S. Cl. CPC G06F 9/5077

(57) ABSTRACT

A device includes a processor configured to obtain a use amount of a plurality of resources allocated to a first information processing system when a response time has exceeded a threshold in the first information processing system among a plurality of information processing systems that operate on a plurality of virtual machines, determine whether or not depletion has occurred in any of the resources in the first information processing system on the basis of the use amount of the plurality of resources, identify a surplus resource, which is a resource other than the depleted resource, from among the plurality of resources on the basis of the use amount of the plurality of resources when it is determined that the excess of the response time is due to the depletion and accommodate the surplus resource to a second information processing system among the plurality of information processing systems.

### CROSS-REFERENCE TO RELATED APPLICATION

This application is based upon and claims the benefit of priority of the prior Japanese Patent Application No. 2015-163971, filed on Aug. 21, 2015, the entire contents of which are incorporated herein by reference.

### FIELD

The embodiments discussed herein are related to a resource management device, a resource management method and a recording medium having stored therein a resource management program.

### BACKGROUND

The wide spread of virtualization techniques has increased cases where a business system such as a core system etc. is also set in a virtual environment. This makes it important that a temporary increase in process requests etc. for example will not affect the business. For this, it is needed to optimize computer resources, which are finite (Patent Documents 1 through 4 for example).

Patent Document 1: Japanese Laid-open Patent Publication No. 2013-239095

Patent Document 2: Japanese National Publication of International Patent Application No. 2013-543171

Patent Document 3: International Publication Pamphlet No. 2007/136021

Patent Document 4: International Publication Pamphlet No. 2012/025977

### SUMMARY

According to an aspect of the embodiments, a resource management device includes a processor configured to obtain a use amount of a plurality of resources allocated to a first information processing system when a response time has exceeded a threshold in the first information processing system among a plurality of information processing systems that operate on a plurality of virtual machines, determine whether or not depletion has occurred in any of the resources in the first information processing system on the basis of the use amount of the plurality of resources, identify a surplus resource, which is a resource other than the depleted resource, from among the plurality of resources on the basis of the use amount of the plurality of resources when it is determined that the excess of the response time over the threshold is due to the depletion in any of the resources, and accommodate the surplus resource to a second information processing system among the plurality of information processing systems.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A and FIG. 1B illustrate an example of selection (first example) of a business system that accommodates resources in a case when a different business system is accommodated with a free space of resources on the basis of a predicted value;

FIG. 2A through FIG. 2C illustrate an example of selection (second example) of a business system that accommodates resources in a case when a different business system is accommodated with a free space of resources on the basis of a predicted value;

FIG. 3 illustrates an example of a resource management device according to the present embodiment;

FIG. 4A and FIG. 4B illustrate a selection example (first example) of a business system that accommodates resources in a case when a different business system is accommodated with a free space of resources according to the present embodiment;

FIG. 5A through FIG. 5C illustrate an example of selection (second example) of a business system that accommodates resources in a case when a different business system is accommodated with a free space of resources according to the present embodiment;

FIG. 6 illustrates a system configuration according to the present embodiment;

FIG. 7 illustrates an example of a business system configuration table according to the present embodiment;

FIG. 8 illustrates an example of a virtual host table according to the present embodiment;

FIG. 9 illustrates an example of a reservation schedule table according to the present embodiment;

FIG. 10 illustrates an example of an accommodation-possible resource management table according to the present embodiment;

FIG. 11 illustrates an entire flow of an accommodation control device 13 according to the present embodiment;

FIG. 12A through FIG. 12C explain a delay prevention period detection process according to the present embodiment;

FIG. 13 illustrates a correlation relationship between the number of requests and the amount of used resources according to the present embodiment;

FIG. 14 illustrates an example of a flow of a reservation schedule addition process executed by a period detection unit according to the present embodiment;

FIG. 15 illustrates an example of a process flow of a delay prevention period calculation process (S11) according to the present embodiment;

FIG. 16 illustrates an example of a process flow of a reservation scheduling process (S12) according to the present embodiment;

FIG. 17 illustrates an example of a flow of a reserved amount determination process executed by a reserved amount setting unit according to the present embodiment;

FIG. 18 illustrates an example of a flow of a determination process of an arrangement destination virtual host and a reserved amount (S21) according to the present embodiment;

FIG. 19 illustrates an example of a flow of a reservation accommodation process (S21-3) according to the present embodiment;

FIG. 20 illustrates an example of a reservation termination process flow executed by a reservation scheduler unit according to the present embodiment;

FIG. 21 illustrates an example of an accommodation-possible resource extraction process flow that is executed by a resource extraction unit according to the present embodiment;

FIG. 22 illustrates an example of a process flow of a surplus resource update process according to the present embodiment (S41);

FIG. 23 illustrates an example of an accommodation-possible resource clearing process executed by a resource extraction unit according to the present embodiment; and

FIG. 24 is an example of a configuration block diagram of a hardware configuration of a computer that executes the programs according to the present embodiment.

### DESCRIPTION OF EMBODIMENTS

When a plurality of virtual machines (VMs) are made to perform processes in a plurality of business systems, resources are sometimes reserved so as to secure them reliably in accordance with the operation schedule of each business system and the degrees of influence of delays on processes. Part or all of surplus resources among reserved resources can be used as complements to insufficient resources when a different system reserves resources. Hereinafter, a resource thus reserved may also be referred to as a “reserved resource”. Reserved resources are secured through accommodation also regarding reserved resources in the actual process phrases, and thereby stable operations of the system is realized.

It takes time to calculate the amount of surplus resources that each business system has in a situation where resources are secured through reservation of them, and estimating current surplus resources from the past record as well as by taking a correlation etc. into consideration may also be possible.

However, accuracy of surplus resources calculated respectively by a plurality of business systems varies between a business system having history information on resources in a past bottleneck state and a business system not having such information. A “bottleneck state” herein refers to a state in which depletion of resources has occurred in one of resources included in an information processing system such as a business system etc. More specifically, a “bottleneck state” refers to a state in which when the use amount has reached the upper limit value of the allocated resources for one of a plurality of resources used in a business system, the processing performance of the entire business system deteriorates remarkably.

As described above, accuracy of surplus resources varies depending upon the presence and absence of the history information on resources in a past bottleneck state. Because of this, accommodation of resources by a business system having a large amount of estimated surplus resources does not always lead to the most appropriate resource distribution as the entirety of a plurality of business systems. For example, a business system that accommodated its resources may become a bottleneck.

In view of this, there is a demand for a technique that suppresses occurrence of depletion of resources in an information processing system that provides resources in a case when resources are provided between information processing systems.

Hereinafter, detailed explanations will be given for a problem of accommodation in response to the occurrence of a bottleneck in a business system.

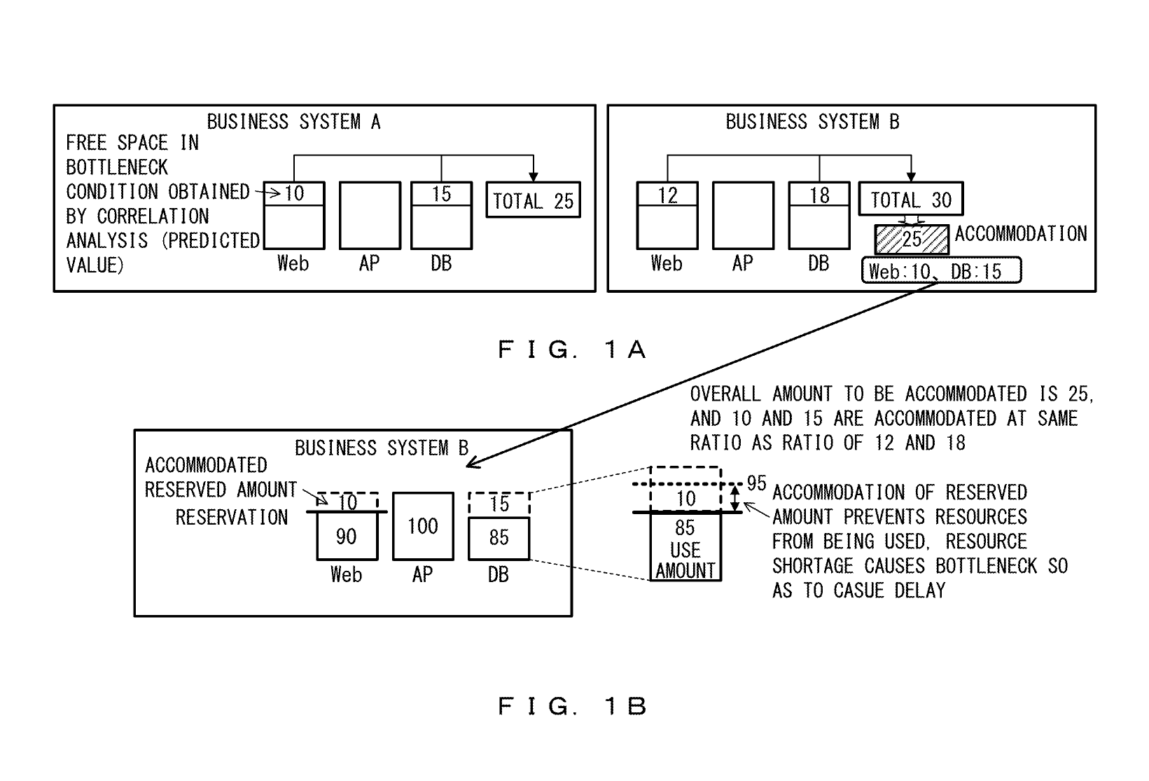

FIG. 1 illustrates an example of selection (first example) of a business system that accommodates resources in a case when a different business system is accommodated with a free space of resources on the basis of a predicted value. As illustrated in FIG. 1A, there exist for example business systems A, B and C. Business systems A and B are assumed to be operating on a virtual host. It is assumed for example that a reservation for business system C was attempted in a reservation scheduler, which performs setting of a resource reservation, but because there are no free physical resources of a virtual host, resources reserved for a different business system is accommodated.

From correlation analysis of the resource use record and the number of requests/s in the past, the amount of used resources at the time of [maximum number of requests that can be processed by the business system]/s (predicted value) is obtained, and the total of free spaces of VMs in the business system in a bottleneck condition is treated as the amount of resources that can be accommodated.

Business system A for example includes a web server, an application (AP) server, a database (DB) server as VMs. It is assumed in business system A that the AP server will have the highest resource consumption amount or the highest resource use rate with respect to the amount of allocated resources, in other words, the AP server will become a bottleneck.

It is also assumed that the amounts of free resources (predicted values) obtained by the correlation analysis in the bottleneck condition are 10 and 15 respectively for the web server and the DB server of business system A. An “amount of free resources in the bottleneck condition” refers to the free space of resources of servers or a ratio at which surplus resources are not used regarding servers other than a server whose resource consumption amount or the resource use rate is 100% in a bottleneck condition in a business system.

For example, a situation when the amount of free resources (predicted value) in the web server in a bottleneck condition is 10 has the following meanings. Specifically, when the resource consumption amount or the resource use rate in the AP server is 100%, the resource consumption amount or the resource use rate in the web server is 90% at a maximum, and a surplus of 10% of resources is predicted.

Business server B includes a web server, an AP server and a DB server as VMs. Similarly in business system. B, it is assumed that the AP server will have the highest resource consumption amount or the highest resource use rate with respect to the amount of allocated resources, in other words, the AP server will become a bottleneck. It is also assumed that the free space of resources (predicted values) obtained by the correlation analysis in the bottleneck condition are 12 and 18 respectively for the web server and the DB server.

The totals of the amounts of free resources are 25 and 30 respectively for business systems A and B. It is herein assumed that one of the business systems is selected for accommodation of its resources. It is assumed for example that business system B, having more free resources than business system A, is selected in the selection of a business system that can accommodate a different system with its resources of a resource amount 25. In such a case, as illustrated in FIG. 1B, reserved amounts of 10 and 15 are accommodated so that the total is 25 on the basis of 12 and 18 as the free spaces (predicted values) of the web server and the DB server of business system B. In other words, accommodation of the reserved amounts is conducted for 10 and 15, which are at the same ratio as that of 12 and 18 as free spaces. Then, the amounts of resources, that are available, of business system B after conducting the accommodation are 90 and 85 for the web server and the DB server, respectively.

When requests increased sharply and unexpectedly in business system B, it is considered that resources exceeding the expected value became needed. In such a case, a shortage corresponding to the accommodated resources occurs so as to cause a response delay.

It is assumed for example that as illustrated in FIG. 1B regarding the DB server of business system B, the amount of resources that is actually needed in response to an unexpected and sharp increase in requests is 95 compared with 85, which is the amount of available resources. Because the DB server in business system B accommodated 15 of the reserved amount, it is not possible for the DB server to use resources set as the reserved amount, and the DB server becomes a bottleneck, causing a response delay because of a resource shortage.

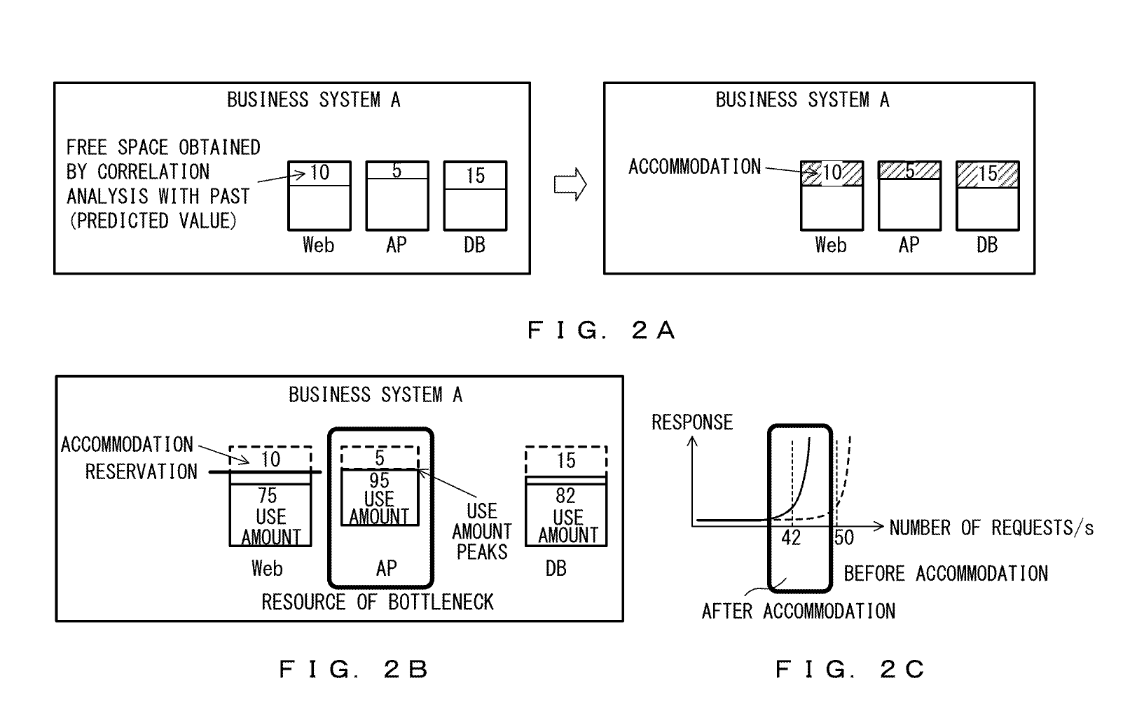

FIG. 2 illustrates an example of selection (second example) of a business system that conducts accommodation of resources in a case when a different business system is accommodated with a free space on the basis of a predicted value. FIG. 2 illustrates an example of a case in which the business system A, having the same configuration as that in FIG. 1, accommodated a different business system with resources without taking bottlenecks into considerations.

As illustrated in FIG. 2A, for every resource of each VM, an increase in the future resource use amount is predicted by correlation analysis of the past resource use record and the current resource use amount that is being monitored, and the free space is treated as the amount of resources that can be accommodated. It is assumed that the amounts of free resources (predicted values) in the bottleneck condition obtained by the correlation analysis are 10 and 15 respectively for the web server and the DB server. Also, “5” that was predicted as the free space for the resources of the AP server that becomes a bottleneck is set as the reserved amount, and is accommodated to a different business system.

It is assumed that at a time of an unexpected and sharp increase in requests in business system A, the resource use amount peaks more than in a state before the accommodation in the bottleneck resources. As a result of this, a response delay occurs earlier than in a state before the accommodation.

For example, as illustrated in FIG. 2B, the resource use amount peaks when the resource use amount has become 100% in the AP server before conducting accommodation, whereas when the resource use amount has become 95% after the accommodation, the resource use amount peaks. As a result of this, a response delay occurs, as illustrated in FIG. 2C, earlier than in a state before the accommodation.

Accordingly, when a surplus resource space is accommodated on the basis of a predicted value of a resource use amount in a bottleneck condition obtained by a correlation analysis etc., it is not possible to handle a sudden increase in requests in some cases.

Regarding reliability of a surplus resource calculated in each of a plurality of systems, actual measurement values of resource use amounts of a case when a bottleneck occurred in the past have such reliability higher than that of predicted values of resource use amounts in a bottleneck condition obtained by a correlation analysis etc. Accordingly, as described above, accommodation of resources by a business system having a large amount of surplus resources obtained on the basis of a predicted value does not always lead to the most appropriate resource distribution as the entirety of a plurality of systems.

When resources were accommodated by a VM that experienced a bottleneck, the degree of influence is very large on a business system that accommodated the resources in a case when the accommodation of the resources was conducted from among surplus resources of respective VMs. Accordingly, uniformly evaluating surplus resources of all VMs so as to conduct evenly a small level of accommodation of resources reduces the impacts on the respective VMs, however, such an approach does not always lead to the most appropriate resource distribution as the entire system.

Further, in order to obtain surplus resources as actual measurement values, the resource use amount is to be analyzed actually in a bottleneck condition. However, a large amount of record data of resource use amounts of all VMs in all business systems needs to be held for a long period of time, and it is not possible to identify a VM that can conduct accommodation from a large amount of data in a short period of time accommodation is to be conducted and to calculate the amount of the resources, and thus it is not possible to conduct accommodation immediately.

In view of the above situation, in a case when there exists a business system in which a bottleneck occurred in the past among a plurality of business systems, the present embodiment gives a priority to surplus resources of that business system in a bottleneck condition as resources to be accommodated when resources are to be accommodated to a different business system. In such a case, resources other than resources that may cause a bottleneck are selectively accommodated so that the accommodation will not affect the business.

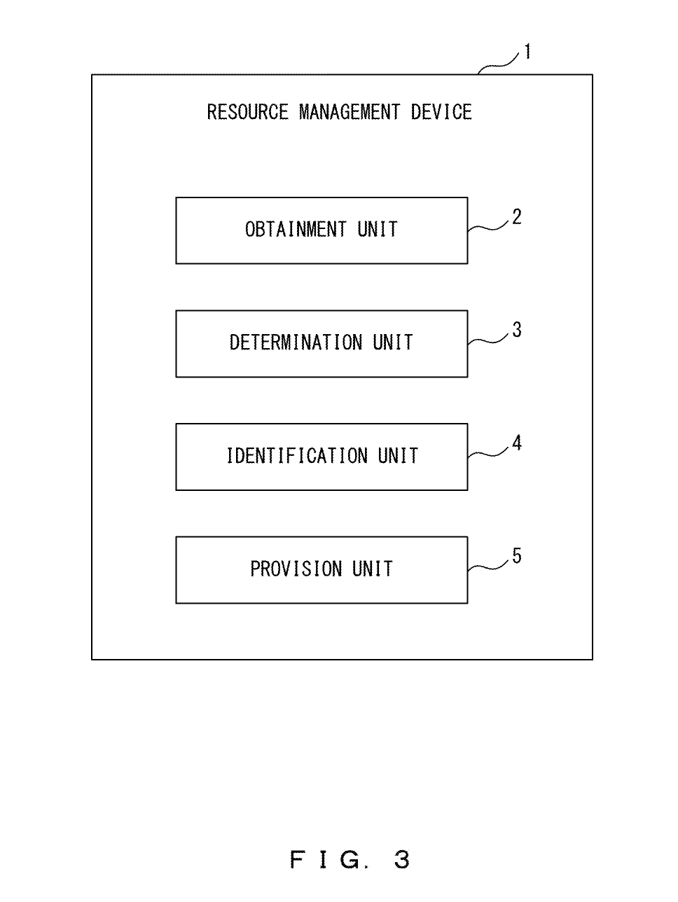

FIG. 3 illustrates an example of a resource management device according to the present embodiment. A resource management device 1 includes an obtainment unit 2, a determination unit 3, an identification unit 4 and a provision unit 5.

When a response time has exceeded a threshold in a first information processing system among a plurality of information processing systems that operate on a plurality of virtual machines, the obtainment unit 2 obtains the use amount of a plurality of resources allocated to the first information processing system. An example of the obtainment unit 2 is a resource extraction unit 17, which will be described later.

The determination unit 3 determines whether or not one of resources has been depleted in the first information processing system on the basis of the use amounts of the plurality of resources. An example of the determination unit 3 is the resource extraction unit 17, which will be described later.

When it is determined that depletion in one of the resources has made the response time exceed the threshold, the identification unit 4 identifies a surplus resource that is other than the depleted resource from among the plurality of resources on the basis of the use amounts of the plurality of resources. An example of the identification unit 4 is a reserved amount setting unit 16.

The provision unit 5 provides a surplus resource to a second information processing system among a plurality of information processing systems. An example of the provision unit 5 is the reserved amount setting unit 16.

This configuration makes it possible to suppress the occurrence of the depletion of resources in an information processing system that provides resources when resources are provided between information processing systems.

When depletion of one of the resources has not occurred in the first information processing system, the identification unit 4 identifies a surplus resource from among a plurality of resources on the basis of information on a relationship between process loads and the amount of resources used in accordance with the process loads.

This configuration makes it possible to obtain surplus resources by identifying a bottleneck resource on the basis of a correlation relationship between process loads and the amount of resources used in accordance with the process loads when a bottleneck did not occur in the past.

Wen one of the resources has depleted, the identification unit 4 identifies, as a surplus resource, a surplus of resources that were being used by a virtual machine at the time of the occurrence of the depletion of one of the resources.

This configuration can treat, as a reserved amount, a surplus of resources used by other virtual machines when a resource used by one of the plurality of virtual machines has become a bottleneck in a business system.

The obtainment unit 2 obtains the use amount of a resource allocated to each of the plurality of virtual machines on which the first information processing system operates when the response time of a process has exceeded the threshold in the first information processing system. The identification unit calculates the surplus amount of resources allocated to virtual machines other than a virtual machine in which the use amount has reached the upper limit value of the allocated resources from among a plurality of virtual machines on which the first information processing system operates. The provision unit provides a calculated surplus amount of a resource to the second information processing system from among the plurality of information processing systems.

This configuration can suppress the occurrence of depletion of a resource in an information processing system as the providing side when resources are provided between information processing systems operating on a plurality of virtual machines.

When a virtual machine in which the use amount has reached the upper limit value of allocated resources has not existed among a plurality of virtual machines on which the first information processing system operates, the identification unit performs the following processes. The identification unit calculates, on the basis of prescribed relationship information, the surplus amount of resources allocated to virtual machines other than a virtual machine in which the use amount has reached the upper limit value of allocated resources among a plurality of virtual machines on which the first information processing system operates. Prescribed relationship information is information related to a relationship between process loads and an amount of resources used in accordance with the process loads.

When a resource used by one of a plurality of virtual machines has become a bottleneck in a business system, the above configuration makes it possible to treat, as a reserved amount, a surplus of resources to be used by other virtual machines.

The present embodiment can realize the following points.

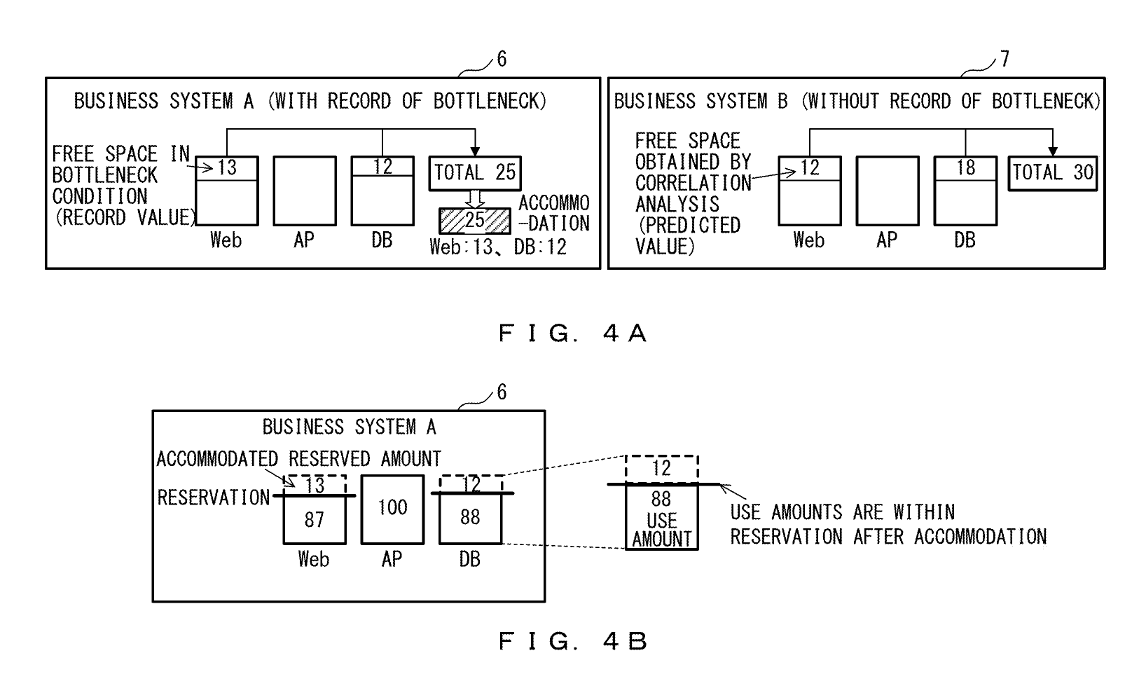

FIG. 4 illustrates a selection example (first example) of an accommodating business system in a case when a different business system is accommodated with a free space of a resource according to the present embodiment. It is assumed as illustrated in FIG. 4A that for example business systems A (6) and B (7) are registered in the reservation scheduler and resources for executing business systems A (6) and B (7) are allocated to a virtual host. It is further assumed that the addition of a reservation of business system C is attempted in the reservation scheduler but there is no free physical resource in the virtual host, and thus a reserved resource for a different business system is to be accommodated.

It is assumed that business system A (6) has a record of having a bottleneck in the past and a surplus resource has been set as a reservation value on the basis of that record. It is assumed that business system. B (7) does not have a record of having a bottleneck and a surplus resource has been set as a reservation value on the basis of a predicted value.

A business system in which a bottleneck occurred in the past is preferentially selected as an accommodating business system. The amount of resources to be accommodated is assumed to be a free space of resources, at an occurrence time of a past bottleneck, other than a resource in which a bottleneck occurred. In the example explained here, it is assumed that business system A, which has a smaller amount of a free resource than that of business system B, satisfies the accommodation resource amount 25, has reliability higher than a predicted value, and had a bottleneck in the past, is selected as illustrated in FIG. 4A.

Even when a sudden and sharp increase in requests has caused a bottleneck in business system A (6), the amount of resources that can be used in a bottleneck condition is secured by the reservation, causing no influence on the accommodation. When for example a sudden and sharp increase in requests has caused a bottleneck in business system A (6) as illustrated in FIG. 4B, there is a high possibility that a bottleneck will occur also this time in the AP server, which has a record of the occurrence of a bottleneck. When a bottleneck has occurred in an AP server, the use amounts of resources in the web server and the DB server are 87 and 88, which are peak values (in other words, the maximum use amounts for the web server and the DB server are 87 and 88, respectively). Accordingly, even when the resources of 13 and 12 as the reserved amounts have been accommodated respectively in the web server and the DB server, the possibility that the resources will be used beyond the maximum use amounts is low, and the use amounts of resources are within the range from which the reserved amounts after the accommodation has been removed. Even when a response delay has occurred, that delay is due to an inherent bottleneck, having nothing to do with the accommodation.

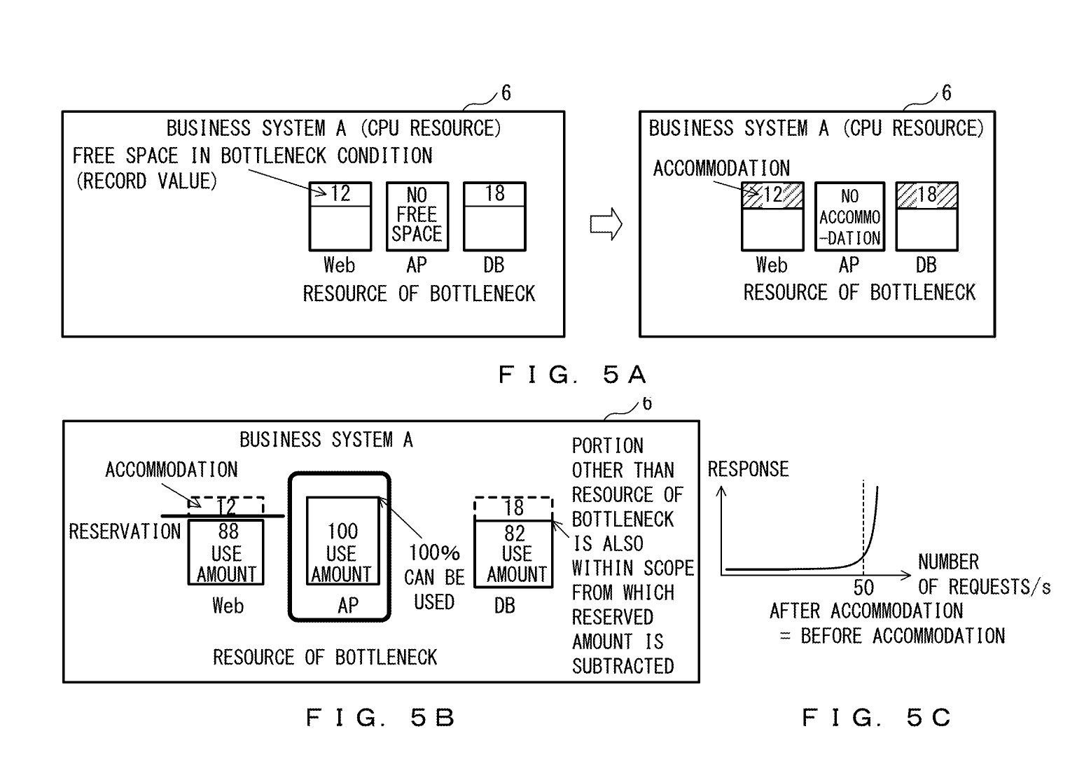

FIG. 5 illustrates an example of selection (second example) of a business system that accommodates resources in a case when a different business system is accommodated with a free space of resources. FIG. 5 illustrates an example in which accommodation of resources that become a bottleneck is prevented so as to suppress influence on the business.

First, a resource to be accommodated is a resource that is used in a business system in which a bottleneck occurred in the past and that has a free space (record value) other than a resource that became a bottleneck. In the case of FIG. 5A, the CPU resource of the AP server in business system A (6) is a resource that becomes a bottleneck and accordingly accommodation of the CPU resource of the AP server is not conducted.

Even when a sudden and sharp increase in requests has caused a bottleneck in business system A (6), the AP server, which is the resource of a bottleneck, can use 100% similarly to the state before the accommodation as illustrated in FIG. 5B. Accordingly, as illustrated in FIG. 5C, no changes are made, between before and after the accommodation, to the AP server for the maximum number of requests (throughput) that can be processed by business system A per unit time, causing no influence due to the accommodation.

Hereinafter, a more specific example of the present embodiment will be explained.

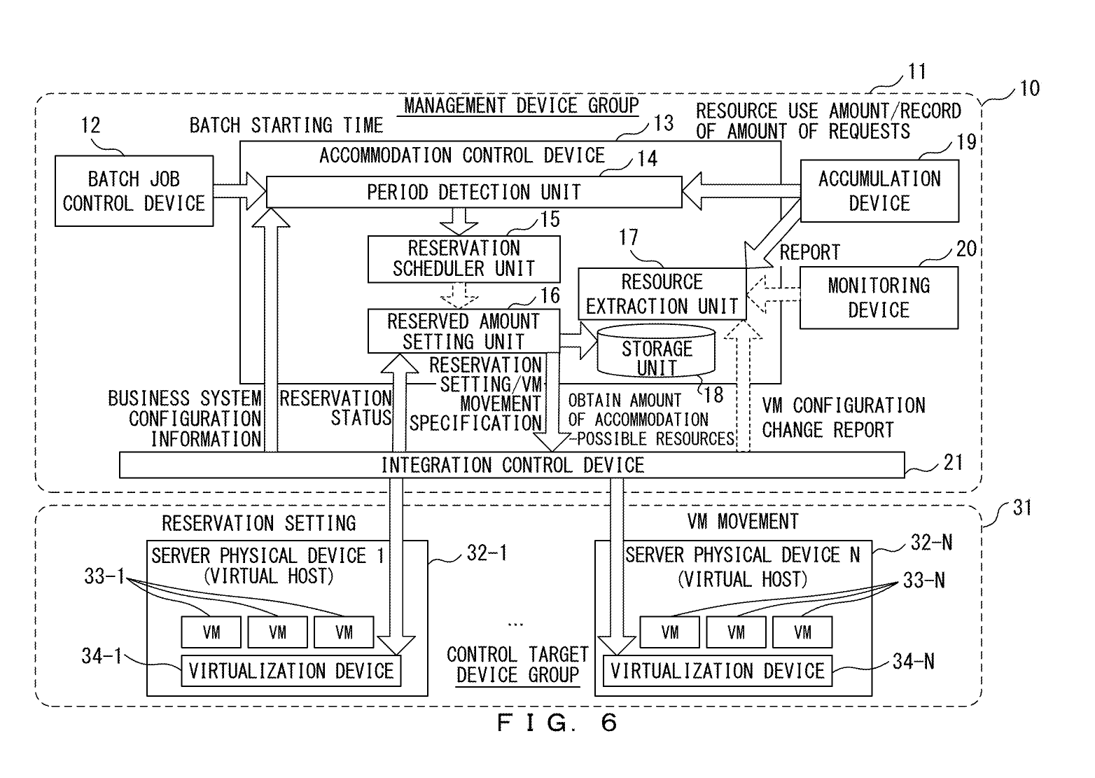

FIG. 6 illustrates a system configuration according to the present embodiment. A system 10 includes a management device group 11 and a control-target device group 31. The control-target device group 31 is a virtualization device group that operates on a server physical device (virtual host) that is a control target. The management device group 11 is a management device group that controls the control-target device group 31.

The control-target device group 31 includes at least one server physical devices 1 (32-1) through N (32-N). Each of the server physical devices 1 (32-1) through N (32-N) functions as a virtual host server (or a virtual host), and includes virtualization devices 34-1 through 34-N.

The virtualization devices 34-1 through 34-N realize virtualization environments in the server physical devices 1 (32-1) through N (32-N), and are control programs (hypervisor, a virtual machine monitor, etc.) that operate a plurality of VMs 33-1 through 33-N.

Hereinafter, the server physical devices 1 (32-1) through N (32-N) are collectively referred to as server physical devices 32 or virtual hosts 32. Also, the virtualization devices 34-1 through 34-N are collectively referred to as virtualization devices 34. Also, the VMs 33-1 through 33-N are collectively referred to as VMs 33.

In the control-target device group 31, a plurality of VMs operate on at least one server physical device 32, and a business system is operated in a virtualization environment.

The management device group 11 is a server group including a batch job control device 12, an accommodation control device 13, an accumulation device 19, a monitoring device 20 and a integration control device 21.

The batch job control device 12 controls a batch process and a job used by a business system. The accumulation device 19 collects, from each business system, the amount of requests to the business system (record value), the use amounts of resources (CPU, memory, etc.) of each VM, and other types of information, and accumulates the collected pieces of information.

The monitoring device 20 monitors the response time of each business system. When a result of the monitoring indicates that a response time has exceeded a threshold, the monitoring device 20 reports that fact to the accommodation control device 13.

The integration control device 21 realizes the execution of the integration and control, in units of business systems, of virtual resources included in the control-target device group. In an example of the present embodiment, the integration control device 21 accommodates a reserved amount set for each virtual resource used by a business system to a different business system as will be described later.

The accommodation control device 13 reserves a resource of each VM in a period (delay prevention period) set for preventing a delay in each business system, and operates it. The accommodation control device 13 performs a reservation accommodation process when the reservation of resources equal to or greater than the physical resources is to be made due to overlapping of delay prevention periods of a plurality of VMs.

In a reservation accommodation process, the accommodation control device 13 preferentially selects a business system in which a bottleneck occurred in the past and which has an amount of resources that can be accommodated with high reliability, on the basis of whether or not each business system registered in advance has a bottleneck and on the basis of the information of surplus resources.

Thereafter, the accommodation control device 13 reserves, as an amount of accommodation-possible resource, the amount of the surplus resource obtained by considering the influence on the business caused by the accommodation.

The accommodation control device 13 includes a period detection unit 14, a reservation scheduler unit 15, a reserved amount setting unit 16, a resource extraction unit 17 and a storage unit 18.

The period detection unit 14 obtains, from the integration control device 21, business system configuration information, which is information representing the configuration of all business systems constructed on the control-target device group 31. The period detection unit 14 obtains a job starting time of the reservation scheduler from the batch job control device 12 on the basis of batch business information associated in the business system. Then, the period detection unit 14 obtains the resource use amount of each VM and the amount of requests of the business system from the accumulation device 19, and determines a delay prevention period.

The reservation scheduler unit 15 registers, in the schedule, a delay prevention period determined by the period detection unit 14. The reservation scheduler unit 15 reports a reservation starting time to the reserved amount setting unit 16.

Receiving a report that the reservation starting time of resources has arrived, the reserved amount setting unit 16 obtains a reservation status of resources of the virtual host 32 from the integration control device 21. When resources can be reserved on one of the virtual hosts 32 in the delay prevention period, the reserved amount setting unit 16 sets a reserved amount in that virtual host. When it is not possible to reserve a surplus resource on one of the virtual hosts 32 in the delay prevention period, the reserved amount setting unit 16 requests that the integration control device 21 accommodate a resource from a virtual host having a surplus resource. Also, the reserved amount setting unit 16 issues, to integration control device 21, an instruction to move a VM.

Receiving from the monitoring device 20 a report that the response of a business system has deteriorated, the resource extraction unit 17 determines presence or absence of the occurrence of a bottleneck in the business system for which that report was made, on the basis of the resource use amount obtained from the accumulation device. In response to presence or absence of a bottleneck, the resource extraction unit 17 uses the record value of the resource use or a correlation relationship between the number of requests and the resource use amount per unit time, and obtains the amount of resources that can be accommodated by that business system. The resource extraction unit 17 registers in an accommodation-possible resource management table 44 the obtained amount of accommodation-possible resource. Receiving a VM configuration change report indicating that the VM configuration of a business system has changed, the resource extraction unit 17 deletes an entry corresponding to that business system from the accommodation-possible resource management table 44.

As will be described later, storage unit 18 includes a business system configuration table 41, a virtual host table 42, a reservation schedule table 43 and the accommodation-possible resource management table 44.

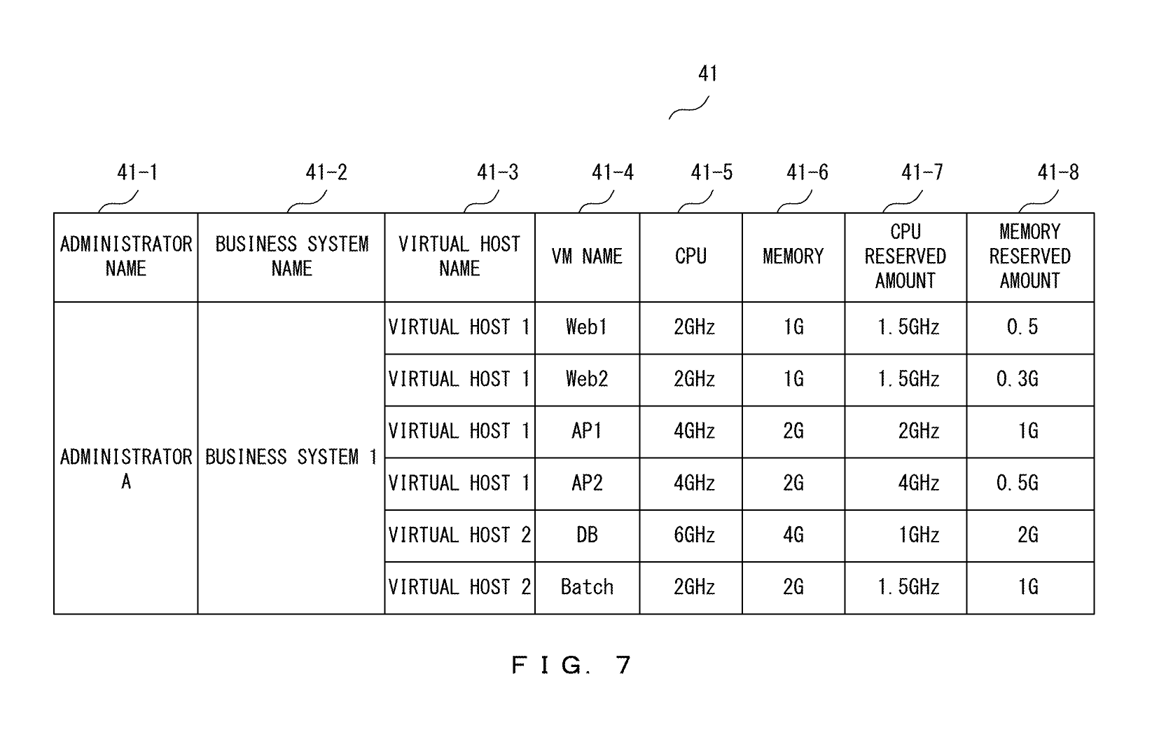

FIG. 7 illustrates an example of a business system configuration table according to the present embodiment. The business system configuration table 41 is a table for managing a virtual resource used in each VM that constitute each business system.

The business system configuration table 41 includes the data items of “administrator name” 41-1, “business system name” 41-2, “virtual host name” 41-3, “VM name” 41-4, “CPU” 41-5, “memory” 41-6, “CPU reserved amount” 41-7 and “memory reserved amount” 41-8.

The “administrator name” 41-1 stores the name of the administrator of the corresponding business system. The “business system name” 41-2 stores the name for identifying the corresponding business system. The “virtual host name” 41-3 stores the name for identifying a virtual host used by the corresponding business system.

The “VM name” 41-4 stores a name for identifying a VM used in the corresponding business system. The “CPU” 41-5 stores the performance of a CPU allocated to the corresponding VM. The “memory” 41-6 stores the space of a memory allocated to the corresponding VM.

The “CPU reserved amount” 41-7 stores the CPU reserved amount that is reserved currently in the performance of a CPU stored in the “CPU” 41-5. The “memory reserved amount” 41-8 stores the memory reserved amount that is reserved currently in the memory space stored in the 41-6.

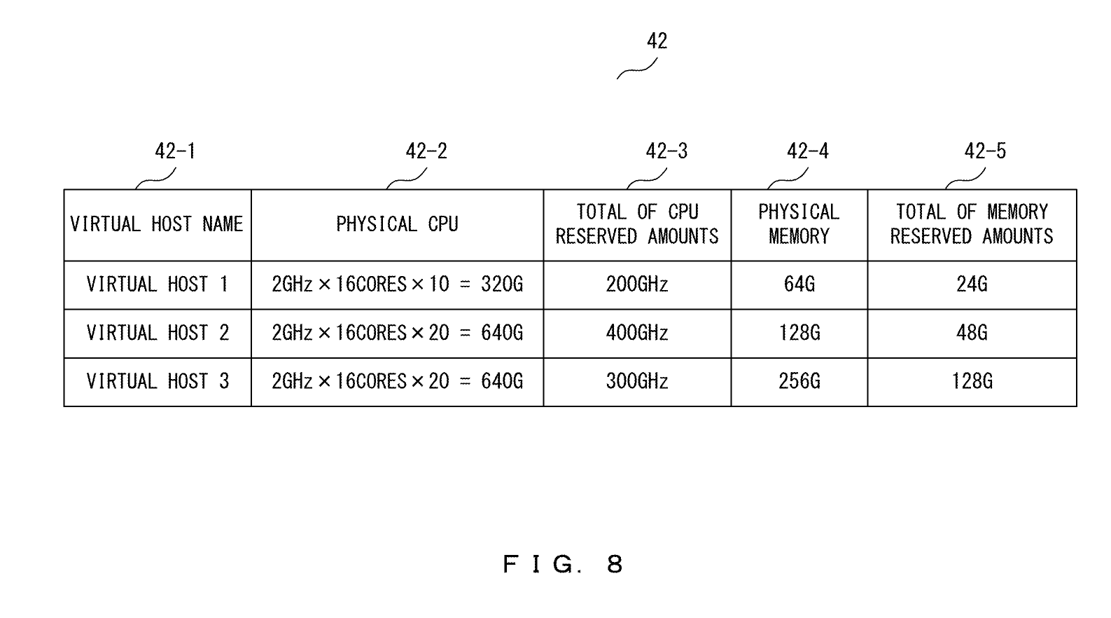

FIG. 8 illustrates an example of a virtual host table in the present embodiment. The virtual host table 42 is a table managing physical resources included in a server physical device that constructs the virtual host 32 and the reserved amount of resources in a reservation period, which will be described later.

The virtual host table 42 includes the data items of “virtual host name” 42-1, “physical CPU” 42-2, “total of CPU reserved amount” 42-3, “physical memory” 42-4 and “total of memory reserved amount” 42-5.

The “virtual host name” 42-1 stores the name for identifying the virtual host 32. The “physical CPU” 42-2 stores the contents of a physical CPU (processing performance (for example 2 GHz×16 cores) and the number) included in a server physical device constructing the virtual host 32. The “total of CPU reserved amount” 42-3 stores the total value of the “CPU reserved amount” 41-7 of a case when grouping is performed by the “virtual host name” 41-3 in the business system configuration table 41. Note that the total of the CPU reserved amount in the virtual host at the current time is stored in the “total of CPU reserved amount” 42-3.

The “physical memory” 42-4 stores the space of a physical memory included in a server physical device that constructs the virtual host 32. The “total of memory reserved amount” 42-5 stores the total value of the “memory reserved amount” 41-8 of a case when grouping is performed by the “virtual host name” 41-3 in the business system configuration table 41. Note that the total of the memory reserved amount in the virtual host at the current time is stored in the “total of CPU reserved amount” 42-3.

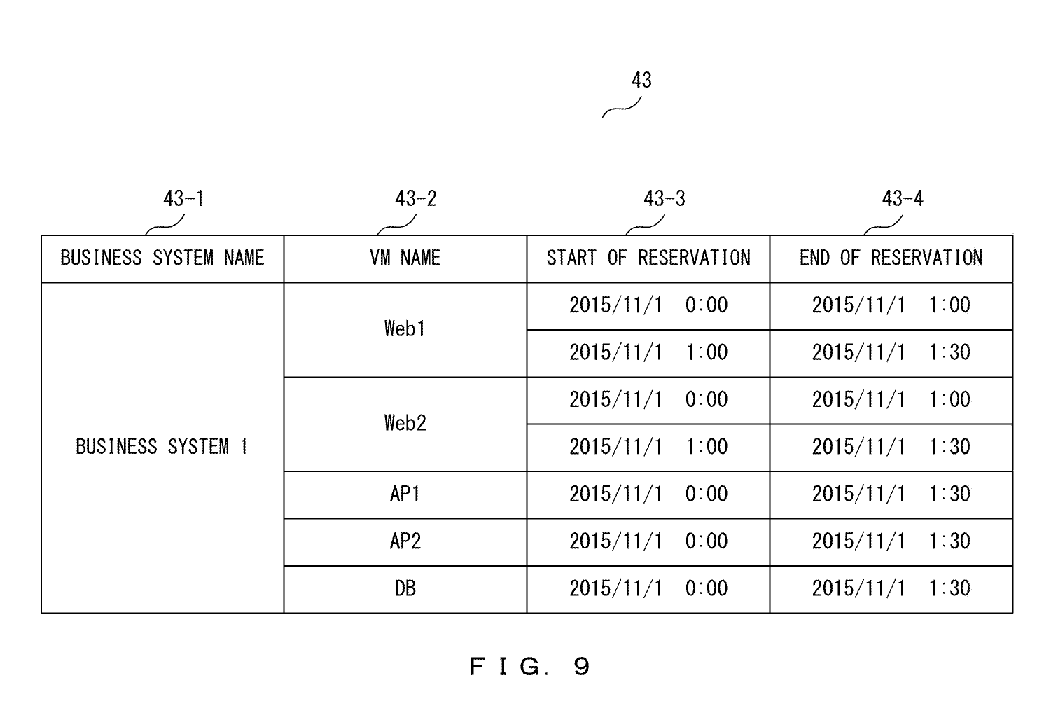

FIG. 9 illustrates an example of a reservation schedule table according to the present embodiment. The reservation schedule table 43 is a table for managing timings of making reservations of resources.

The reservation schedule table 43 includes “business system name” 43-1, “'VM name” 43-2, “reservation start” 43-3 and “reservation end” 43-4. The “business system name” 43-1 stores the name for identifying the corresponding business system. The “VM name” 41-2 stores a name for identifying a VM used in the corresponding business system. The “reservation start” 43-3 and the “reservation end” 43-4 respectively store the starting and ending times for accommodating resources that were reserved so that they can be accommodated between business systems.

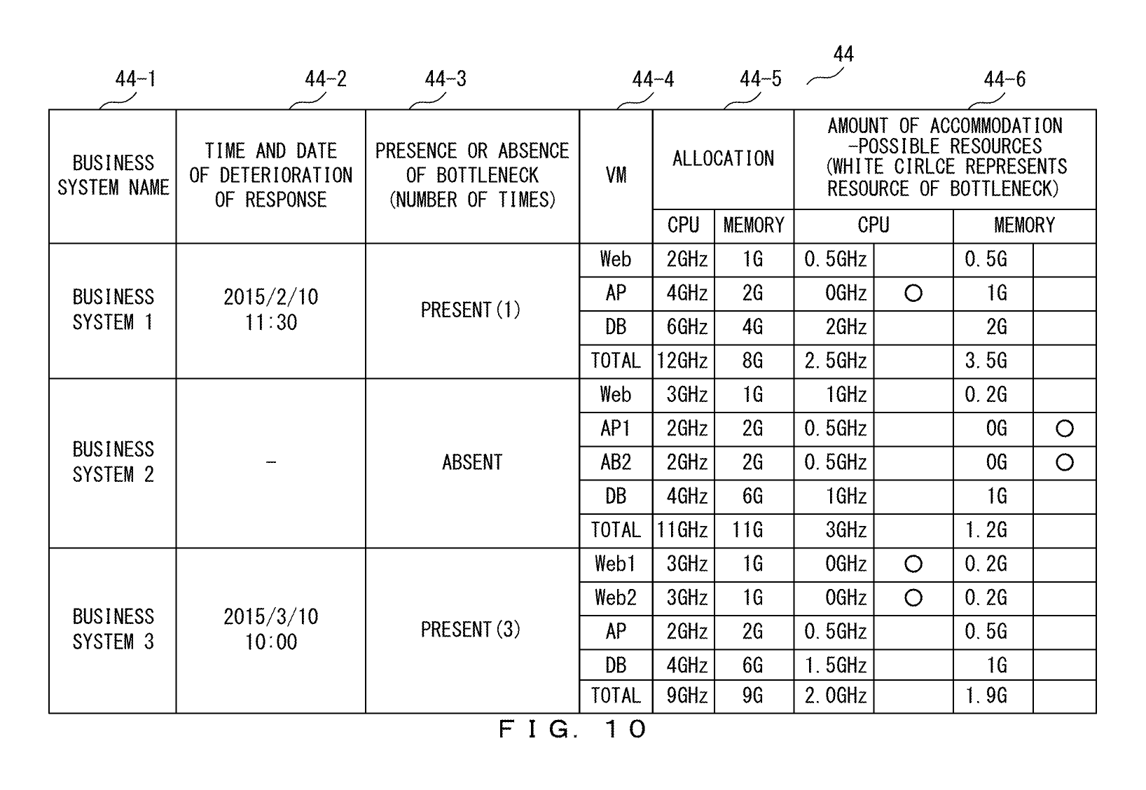

FIG. 10 illustrates an example of an accommodation-possible resource management table according to the present embodiment. The accommodation-possible resource management table 44 is a table managing accommodation-possible resources in units of business systems. In the accommodation-possible resource management table 44, the contents of the entries are recorded or updated in units of business systems upon the occurrence of the deterioration of a response of a business system. This makes it possible to use the accommodation-possible resource management table 44 immediately upon the accommodation of resources.

The accommodation-possible resource management table 44 includes the data items of “business system name” 44-1, “time and date of deterioration of response” 44-2, “presence or absence of bottleneck (number of times)” 44-3, “VM name” 44-4, “allocation” 44-5 and “amount of accommodation-possible resource” 44-6. Note that in the accommodation-possible resource management table 44, one entry is prepared for one business system.

The “business system name” 44-1 stores the name for identifying the corresponding business system. The “time and date of deterioration of response” 44-2 stores the time and date at which the latest response deterioration occurred.

The “presence or absence of bottleneck (number of times)” 44-3 stores the presence or absence of bottlenecks and the number of times of the occurrence in the corresponding business system. When “absent” is registered in the “presence or absence of bottleneck (number of times)” 44-3, it is meant that no bottleneck occurred in the past. The presence or absence and the number of times of occurrence of bottlenecks represent the reliability for the resources accommodation. In the example illustrated in FIG. 10, the priority of the resource accommodation is in the order of “present (3)”, “present (1)” and “absent”.

The “VM name” 44-4 stores the name for identifying a VM used in the corresponding business system. The “allocation” 44-5 stores the space of a resource (performance of the CPU and the space of the memory) allocated to the corresponding VM.

The “amount of accommodation-possible resource” 44-6 stores the amount of accommodation-possible resources (performance of the CPU and the space of the memory) out of the amount of resources used by a VM used by the business system. The resources with white circles in the “amount of accommodation-possible resource” 44-6 are resources of bottlenecks (the amount of accommodation-possible resources of resources with a white circle is “0”). Also, the “amount of accommodation-possible resource” 44-6 stores the total of accommodation-possible resources for each business system.

Herein, the “presence or absence of bottleneck (number of times)” 44-3 and the “amount of accommodation-possible resource” 44-6 will be explained in more detail. The “amount of accommodation-possible resource” 44-6 preferentially stores a record value at the time of the occurrence of a bottleneck and “presence or absence of bottleneck (number of times)” 44-3 stores “present”.

When a bottleneck occurs a plurality of times, the “amount of accommodation-possible resource” 44-6 stores a minimum value as a record value for the purpose of safety, and the “presence or absence of bottleneck (number of times)” 44-3 stores the number of times of occurrence of bottlenecks.

When a bottleneck does not occur at all, the “amount of accommodation-possible resource” 44-6 stores a predicted value based on a correlation analysis. Then, “absent” is stored in the “presence or absence of bottleneck (number of times)” 44-3. Note that also when a calculation of a predicted value based on a correlation analysis has determined that there is a bottleneck in a resource, a white circle is stored in “amount of accommodation-possible resource” 44-6 of that resource.

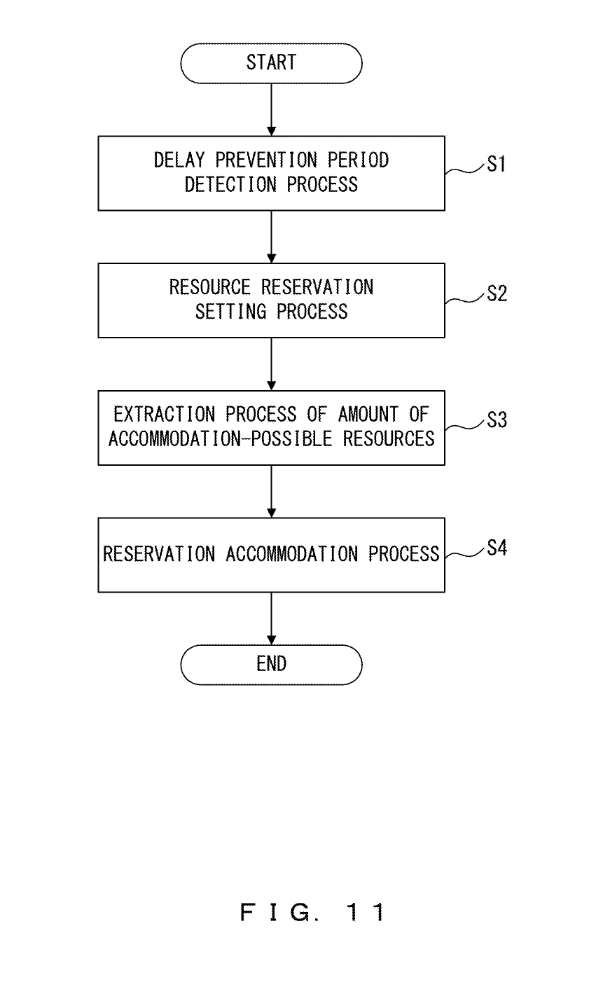

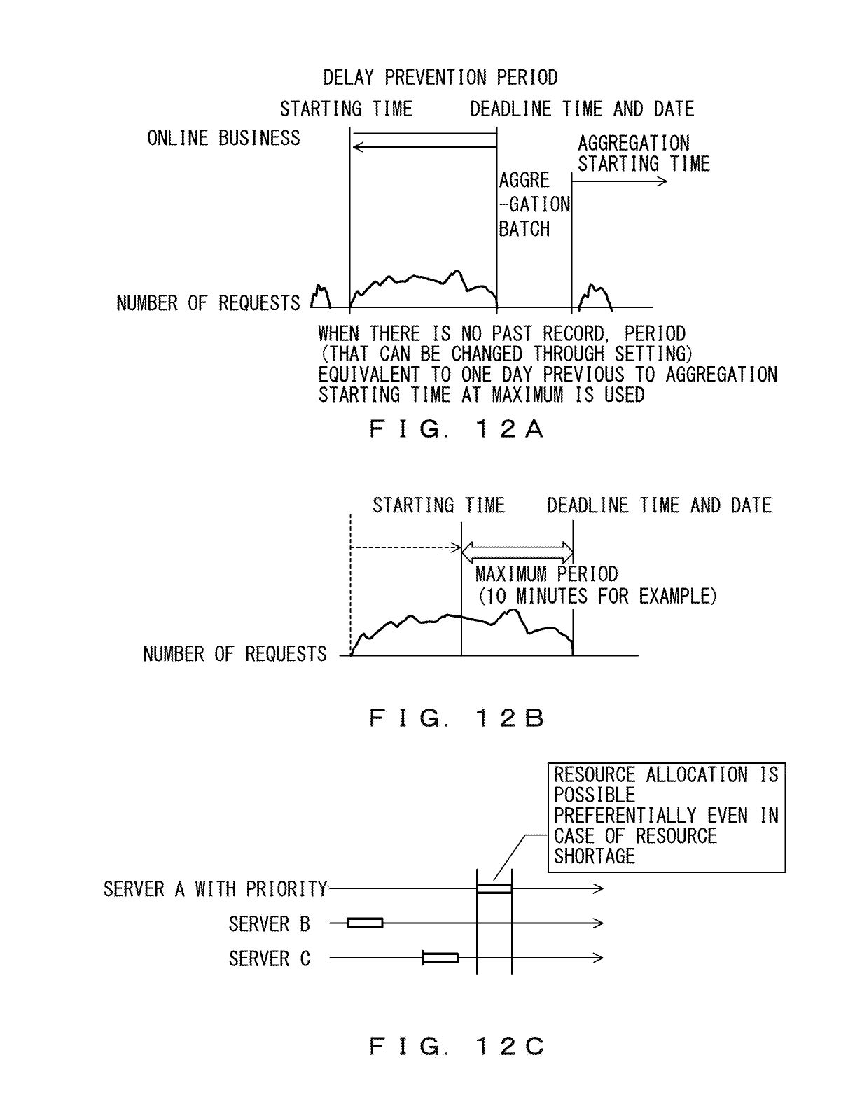

FIG. 11 illustrates an entire flow of the accommodation control device 13 according to the present embodiment. The accommodation control device 13 functions as the period detection unit 14, and performs a delay prevention period detection process (S1). The process in S1 will be explained by referring to FIG. 12.

FIG. 12 explains a delay prevention period detection process according to the present embodiment. The period detection unit 14 detects a period in which delays in businesses are prevented (delay prevention period) as illustrated in FIG. 12A in a business system linked with a batch process.

First, at a timing of adding an online business or updating the setting of a VM that constitutes an online business, the period detection unit 14 obtains an aggregation starting time of batch businesses associated with the online business.

A business that is a target in this example is a combination of an online business and a batch business of a process of aggregating/analyzing data received in a prescribed period, the process being performed after the deadline day of the period. An example of an online business is ticket reservation, and the prescribed period corresponds to a reservation period of tickets (from the start of the reservation to the end (deadline day) of it).

Also, when the ending time of the reservation period is determined, a batch business is assumed to be scheduled by treating the period after the ending time as the execution starting time.

The period detection unit 14 extracts (a crest of) requests immediately previous to the obtained aggregation starting time from logs in the web server in an online business.

The period detection unit 14 determines a delay prevention period in the following manner. In FIG. 12A, the first the deadline time is the starting time of the batch business. Regarding the next and subsequent times, the ending time of a period including consecutive accesses before the aggregation starting time is treated as the deadline time and date from the record of the number of past requests.

The first starting time is a one-day period (that can be changed through setting) equivalent to one day previous to the aggregation starting time. Regarding the next and subsequent times, the starting time of a period with consecutive accesses is treated as a starting time.

When the delay prevention period determined above has exceeded the maximum period (10 minutes for example) which is prescribed in advance, the period detection unit 14 treats that maximum period as the delay prevention period as illustrated in FIG. 12B. The maximum period in which the transaction process time requested before the deadline time and date is not over the deadline time and date is set in advance. Because that maximum period is the minimum period that does not exceed for example the transaction process time of updating a DB etc. in an online business, the maximum period may be about 10 minutes at the longest.

When the period between the starting time and the deadline time of the crest of the number of requests has exceeded the maximum period, a time that is earlier by the length of the maximum period than the deadline time and date is treated as the starting time. This is for minimizing the reservation period so as to allocate preferentially the reservation period to a VM that needs resources.

The period detection unit 14 registers the delay prevention period obtained above in the reservation schedule table 43 as illustrated in FIG. 12C. Thereby, it is also possible to prevent the deterioration of the performance of a business system by dynamically calculating a period of preferentially allocating resources as a period that is as short as possible in order to minimize competition for resources.

FIG. 11 is explained again. Next, the accommodation control device 13 functions as the reserved amount setting unit 16 so as to perform a resource reservation setting process (S2). In S2, the reserved amount setting unit 16 starts a resource reservation setting process on a target VM 33 of a target business system corresponding to a reservation starting time when the reservation starting time (starting time of the delay prevention period) registered in the reservation schedule table 43 has arrived.

When the amount of reserved resources does not exceed the upper limit of the physical resources of the operating virtual host 32 even after the reservation of resources for the target VM 33, the reserved amount setting unit 16 sets the reservation of resources of 100% with respect to the amount of allocated resources, and terminates the process.

Then, in a delay prevention period, the reserved amount setting unit 16 conducts the setting in which 100% of resources can be allocated to the target VM 33 at the starting time of the delay prevention period, i.e., the reserved amount setting unit 16 makes a reservation. When the deadline time and date has arrived, the reservation scheduler unit 15 cancels that reservation.

When the target VM 33 that received a reservation in the reservation period (between the reservation starting time and the reservation ending time) needs resources, the reserved amount setting unit 16 can preferentially allocate resources even when a different VM 33 that has not received a reservation is using those resources. By contrast, the amount of resources (CPU resources for example) not used by the VM 33 having received a reservation can be used by a different VM.

The upper limit of resources that can be reserved is the upper limit of the physical resources of that virtual host 32 (strictly, it is an upper limit resulting form subtracting the amount used by the hypervisor or the overhead of each VM 33). Accordingly, the upper limit under which a plurality of delay prevention periods can be overlapped is the upper limit of the reservation (i.e., upper limit of physical resources).

Next, the accommodation control device 13 functions as the resource extraction unit 17 and performs an extraction process of the amount of resources that can be accommodated (S3). In S3, the resource extraction unit 17 determines resources that can be accommodated from a business system having not accommodated its resources and also determines the amount of those resources when the accommodation is conducted, and registers the results in the accommodation-possible resource management table 44.

The timing of obtaining the amount of resources that can be accommodated is when the deterioration of a response is occurring for each business system, i.e., when a response time monitored by the monitoring device 20 has exceeded a threshold.

The resource extraction unit 17 determines whether or not the excess of the response time over the threshold is due to a bottleneck in that business system. Specifically, when the response deteriorated (when the response time exceeded the threshold), the resource extraction unit 17 determines whether or not a bottleneck has occurred in that business system on the basis of the resource use amounts (recorded values) or the amounts of requests (recorded values) collected by the accumulation device 19.

The determination about a bottleneck is conducted on the basis of whether or not 100% of allocated resources have been used for any of resources (CPU or memory) of the VM 33 used in a business system. The resource extraction unit 17 registers, in the accommodation-possible resource management table 44 and as resources of bottlenecks, resources that have used 100% of the amount of allocated resources.

Upon the registration, the resource extraction unit 17 treats resources having a free resource amount as surplus resources so as to treat such resources as resources that can be accommodated from among resources other than resources determined to be a bottleneck. Next, regarding resources other than resources of a bottleneck, the resource extraction unit 17 treats the amount of resources used at the number of requests that caused a bottleneck as the amount of resources used in a bottleneck condition and also treats a free space as surplus resources. When a bottleneck occurred also in the past, the minimum value for surplus resources is used as the amount of resources that can be accommodated in order to increase the safety.

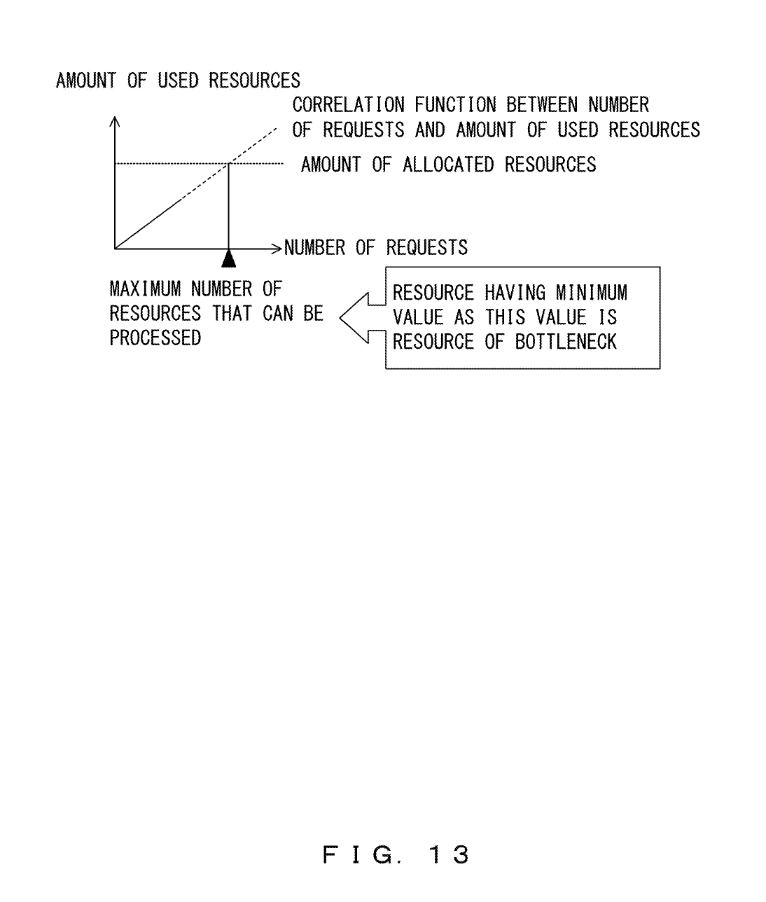

When a bottleneck has not occurred, there is a possibility that the resources will further be used. In such a case, the resource extraction unit 17 obtains a correlation relationship between the number of requests and the resource use amount of each VM (CPU use amount and memory use amount) for each business system as illustrated in FIG. 13. Then, on the basis of the obtained correlation relationship, the resource extraction unit 17 registers, on the accommodation-possible resource management table 44 and as resources of a bottleneck, resources that first reach the upper limit due to an increase in the number of requests.

Note that the amount of resources that can be accommodated changes when a change is made to a VM such as a change in the configuration of a VM (a change in the resource allocation, addition and deletion of a VM, etc.), replacement of an application program with new one in a VM, a change in a system parameter, etc. Accordingly, the amount of resources that can be accommodated is recalculated so as to be registered in the accommodation-possible resource management table 44.

Next, the accommodation control device 13 functions as the reserved amount setting unit 16 so as to perform a reservation accommodation process (S4). In S4, when the resources have been reserved up to the upper limit of the physical resources of all the virtual hosts 32, the reserved amount setting unit 16 uses the following methods so as to accommodate resources needed to execute a process in the business system that received the reservation from a business system having resources that can be accommodated.

The reserved amount setting unit 16 uses, as resources that can be accommodated, surplus resources of a case when a bottleneck was cased when the response of the business system deteriorated. When a business system serving as the accommodation source is first selected, the reserved amount setting unit 16 preferentially selects a business system determined to involve a bottleneck when the deterioration of a response occurred in the past. This is because regarding a business system in which a bottleneck occurred, a free space of resources other than the resources of the bottleneck at that time has high reliability as an amount that will not further be used. Also, regarding business systems with great numbers of times of the occurrence of bottlenecks, the priority orders are made to be higher for the following two reasons.

1) The fact that business systems with a great number of times of the occurrence of bottlenecks do not particularly respond to such bottlenecks regardless of that responses became deteriorated duet to bottlenecks many times, which means that a degree of influence on the businesses can be considered small.
2) The fact that regarding business systems with a great number of times of the occurrence of bottlenecks, the amounts of surplus resources other than resources of bottlenecks are clear.

Next, the reserved amount setting unit 16 treats the amount of fee resources of a VM that has not become a bottleneck (=allocated amount−used amount) as the amount of resources that can be accommodated. The reserved amount setting unit 16 does not accommodate resources that became bottlenecks to a different business system. Thereby, the amount of resources peaks due to a bottleneck involved in an accommodating business system even when the number of requests have increased sharply in that accommodating business system after the accommodation, it is possible to suppress influence (deterioration of responses) of the accommodation on businesses. In such a case, accordingly, the risk of the influence on businesses does not vary before and after the resource accommodation.

When an accommodation source is to be selected from among a plurality of business systems under a condition that the business systems have the same number of times of the occurrence of bottlenecks or they do not have bottlenecks, the reserved amount setting unit 16 preferentially selects the business system with the greatest total value of amounts of resources that can be accommodated. Particularly when accommodation is to be conducted from a business system with low reliability, it is for the purpose of increasing the safety by leaving as many surplus resources as possible after the accommodation.

When one business system does not have a sufficient amount of resources needed for the accommodation, the reserved amount setting unit 16 conducts accommodation from a plurality of business systems. When there are no more resources that can be accommodated, the reserved amount setting unit 16 reports a failure in the accommodation to the administrator.

As described above, by the flow illustrated in FIG. 11, it is possible to prevent a delay in businesses from being caused by a resource shortage due to accommodation even when requests increased suddenly and unexpectedly in both of the business systems that accommodated each other.

Hereinafter, the flow illustrated in FIG. 11 will be explained in detail. Specifically, processes of the period detection unit 14, the reservation scheduler unit 15, the reserved amount setting unit 16 and the resource extraction unit 17 will be explained in detail.

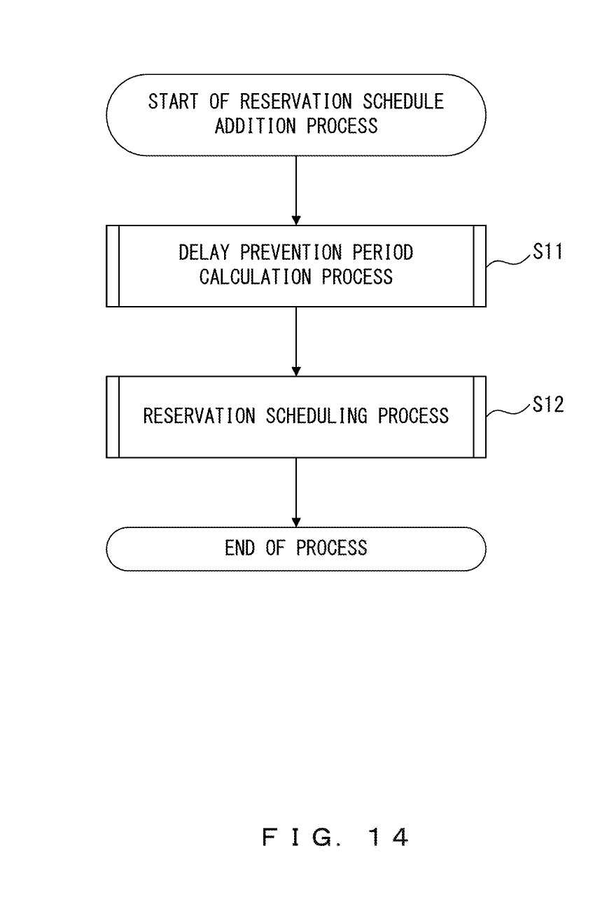

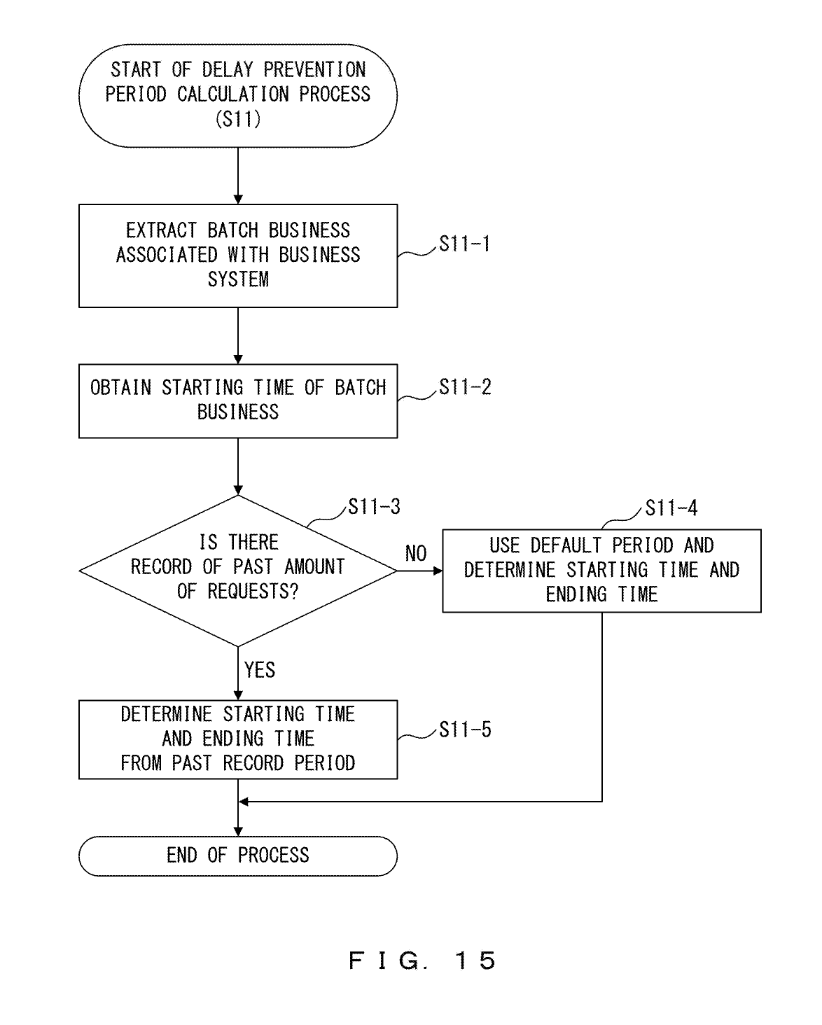

FIG. 14 illustrates an example of a flow of a reservation schedule addition process executed by a period detection unit according to the present embodiment. When a new business system has been added to the business system configuration table 41 or when a starting schedule of a batch business process has been added or changed, the period detection unit 14 performs a delay prevention period calculation process (S11). The period detection unit 14 obtains the starting time of a job so as to calculate the reservation starting time and the reservation ending time from the record of the amount of past requests. The process in S11 will be described in detail by referring to FIG. 15.

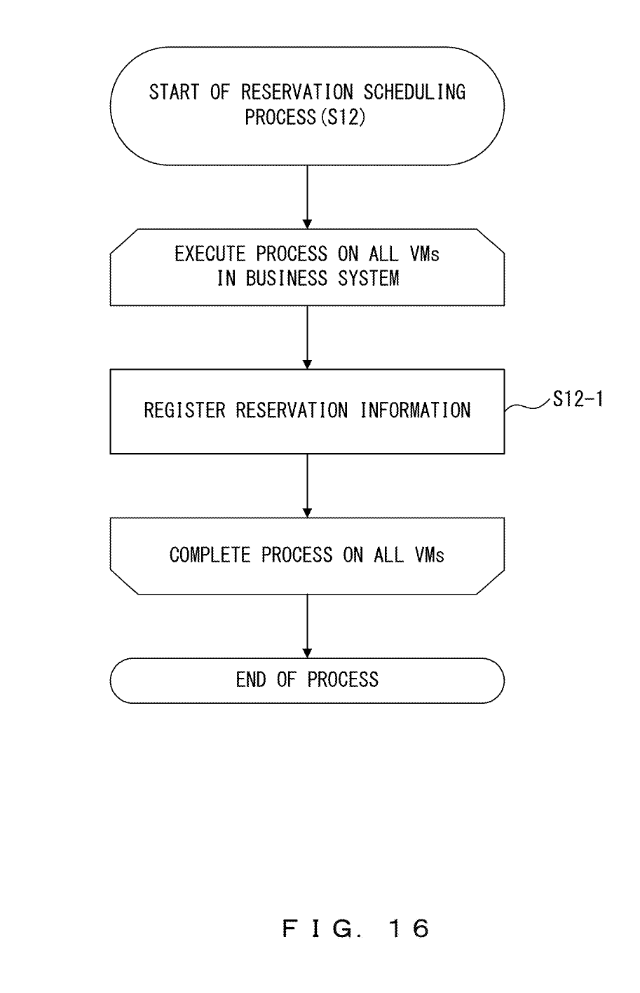

Next, the period detection unit 14 performs a reservation scheduling process (S12). The period detection unit 14 registers, in the reservation schedule table 43, the calculated reservation starting time and the reservation ending time. The process in S12 will be described in detail in FIG. 16.

FIG. 15 illustrates an example of a process flow of a delay prevention period calculation process (S11) according to the present embodiment. The period detection unit 14 obtains business system configuration information, which is information for managing the configuration of a business system, from the integration control device 21 and stores it in the business system configuration table 41. The period detection unit 14 stores, in the virtual host table 42 and for each virtual host, the total value of the “CPU reserved amount” 41-7 in a reservation period of a case when grouping was conducted by the “virtual host name” 41-3 in the business system configuration table 41. In the business system configuration table 41, the period detection unit 14 stores, in the virtual host table 42 and for each virtual host, the total value of the “memory reserved amount” 41-8 in a reservation period of a case when grouping was conducted by the “virtual host name” 41-3 in the business system configuration table 41.

The period detection unit 14 extracts a batch business name (business system name) and the VM name and the virtual host name that execute the batch from the business system configuration table 41 as batch information associated to an online business. The period detection unit 14 searches for a batch corresponding to the extracted batch business name and VM name from the batch job control device 12 (S11-1). The period detection unit 14 obtains the starting time of that batch from the schedule information of the batch that was searched for.

When there is a record of setting a reserved amount in the past on the basis of the amount of requests for the business system that executes that batch (Yes in S11-3), the reservation starting time and the reservation ending time are determined on the basis of the past record period.

When there is no record of setting a reserved amount in the past on the basis of the amount of requests for a business system or it is a business system that was added newly (No in S11-3), the period detection unit 14 determines the reservation starting time and the reservation ending time by using a default period (S11-4).

FIG. 16 illustrates an example of a process flow of a reservation scheduling process (S12) according to the present embodiment. The period detection unit 14 registers, in the reservation schedule table 43, a determined reservation period (from the starting time to the ending time) for a VM used in each business system that became a process target in S11 (S12-1).

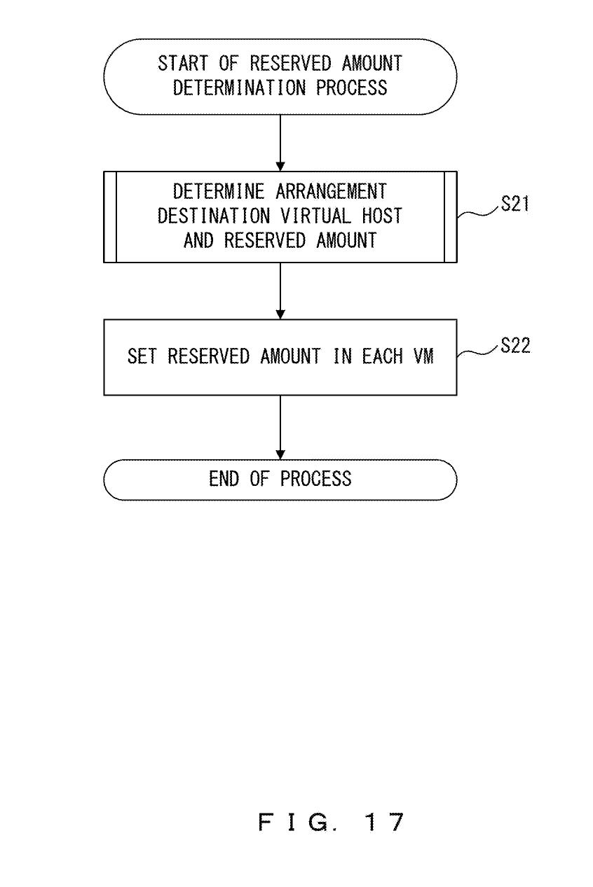

FIG. 17 illustrates an example of a flow of a reserved amount determination process executed by a reserved amount setting unit according to the present embodiment.

When the reserved amount setting unit 16 has determined by referring to the reservation schedule table 43 that the reservation period of one of the business systems has started, the reserved amount setting unit 16 performs a process of determining an arrangement destination virtual host and the reserved amount (S21). The reserved amount setting unit 16 performs a reservation accommodation process when the reservation of resources equal to or greater than the physical resources is to be made due to overlapping of reservation periods (delay prevention periods) of a plurality of VMs. In other words, the reserved amount setting unit 16 selects a virtual host (arrangement destination virtual host) that can secure resources needed for operating each VM used in a business system (target business system) in which the reservation period has started. The reserved amount setting unit 16 moves a VM between business systems or virtual hosts if desired.

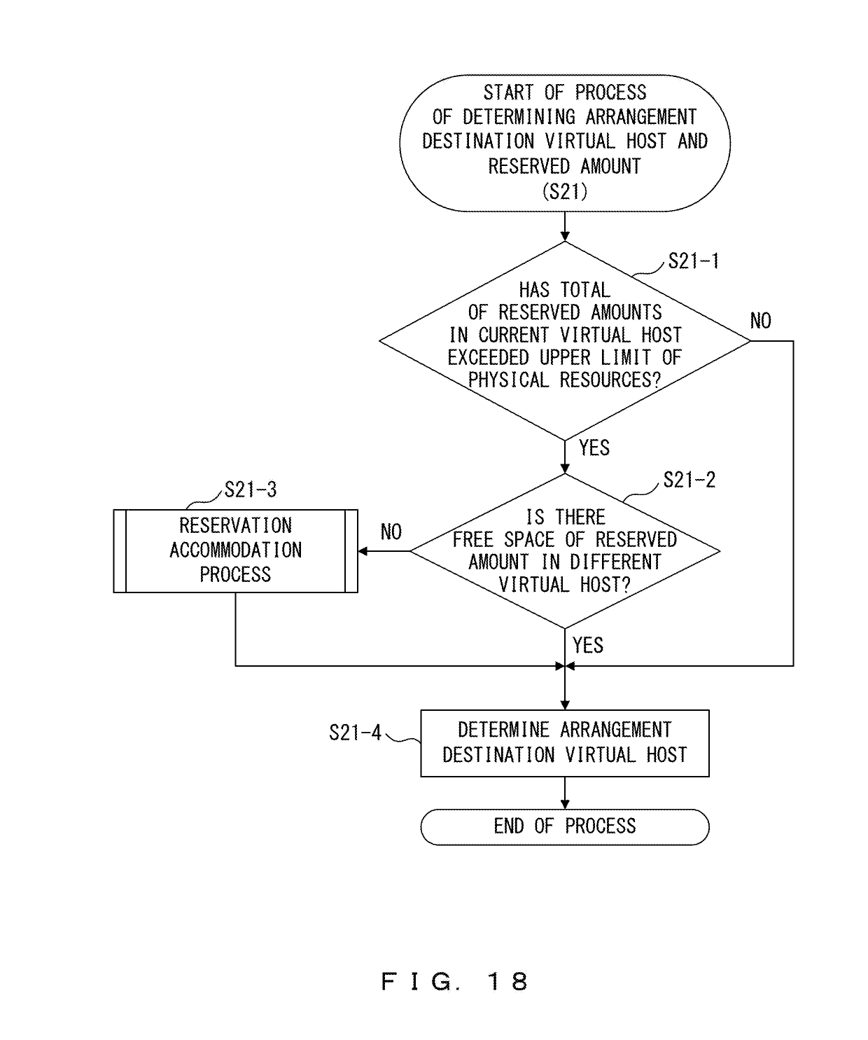

When none of the virtual hosts has resources needed for operating all VMs used in a target business system, the reserved amount setting unit 16 performs a reservation accommodation process. In the reservation accommodation process, the reserved amount setting unit 16 refers to the accommodation-possible resource management table 44 so as to accommodate resources for operating the target business system from a business system in which a bottleneck is “present”. When there is no system in which a bottleneck is “present”, the reserved amount setting unit 16 accommodates surplus resources from a system in which a bottleneck is “absent”. S21 will be explained in FIG. 18.

Next the reserved amount setting unit 16 sets a reserved amount for each VM operating in an arrangement destination virtual host determined in S21 (S22). When the amount of resources used in a VM in a virtual host does not exceed the physical resources of the virtual host 32 in the reservation period in S21 as will be described later, the reserved amount setting unit 16 performs the following process. Specifically, the reserved amount setting unit 16 sets in the business system configuration table 41 the amount of resources equivalent to 100% of the amount of resources allocated to each VM operating in the arrangement destination virtual host.

FIG. 18 illustrates an example of a flow of a determination process of an arrangement destination virtual host and a reserved amount (S21) according to the present embodiment.

In the virtual host table 42, the reserved amount setting unit 16 selects a virtual host in which a VM of a target business system is operating. The reserved amount setting unit 16 determines from the virtual host table 42 whether or not the total of the reserved amounts in a virtual host in the reservation period has exceeded the upper limit of the physical resources in the selected virtual host. A total of the reserved amount in a virtual host in the reservation period refers to values stored in the “total of CPU reserved amount” 42-3 and the “total of memory reserved amount” 42-5 in the virtual host table 42. The upper limit of the physical amount refers to values stored in the “physical CPU” 42-2 and the “physical memory” 42-4 in the virtual host table 42.

When total of the reserved amounts of the selected virtual host has not exceeded the upper limit of the physical amount (No in S21-1), the reserved amount setting unit 16 makes the process proceed to S21-4.

When the total of the reserved amounts of the selected virtual host has exceeded the upper limit of the physical amount, (Yes in S21-1), the reserved amount setting unit 16 sequentially selects, in the virtual host table 42, other virtual hosts so as to determine whether or not the selected host has a free resource amount that can be reserved (S21-2). In S21-2, the process of S21-1 is performed on other virtual hosts.

When the selected virtual host has a free resource amount that can be reserved (Yes in S21-2), the reserved amount setting unit 16 makes the process proceed to S21-4.

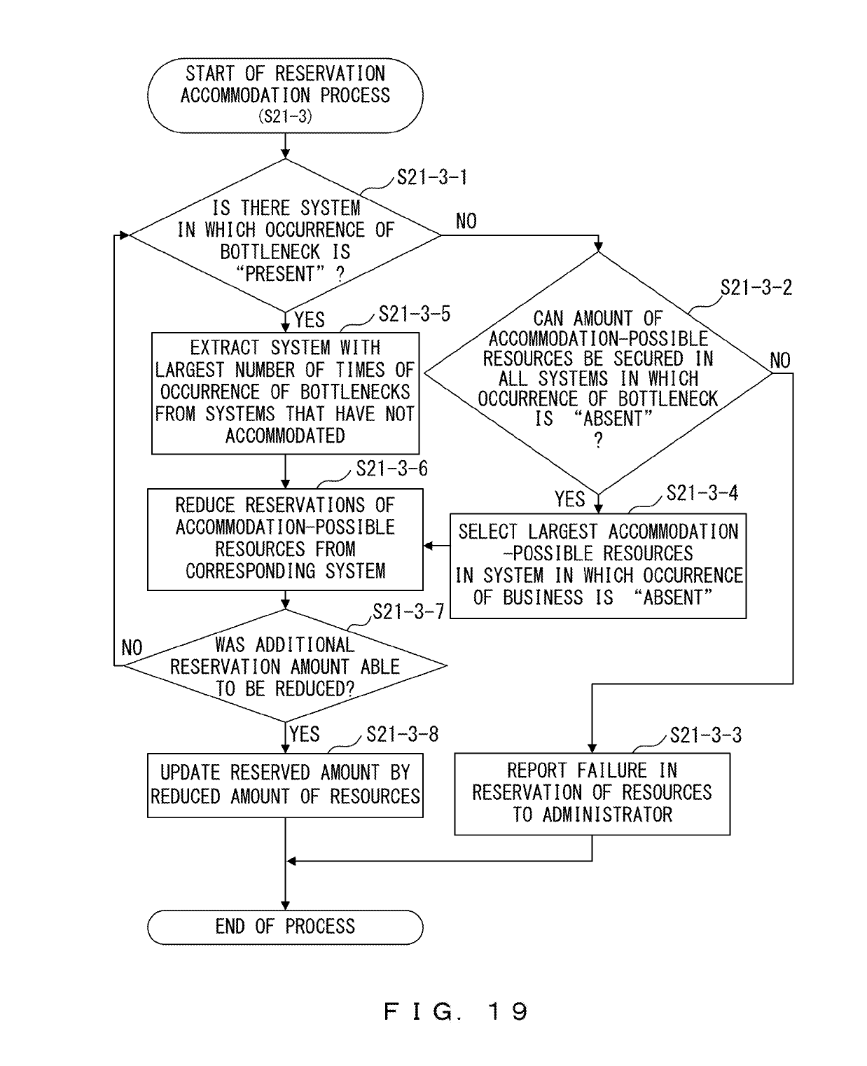

None of the virtual hosts has a free resource amount that can be reserved (No in S21-2), the reserved amount setting unit 16 performs a reservation accommodation process in order to secure resources that are needed (S21-3). S21-3 will be explained in FIG. 19.

When the result in S21-1 is No or the result in S21-2 is Yes, the reserved amount setting unit 16 treats the selected virtual host as an arrangement destination virtual host. When a reservation accommodation process (S21-1) has been performed, the reserved amount setting unit 16 treats the accommodating virtual host as an arrangement destination virtual host.

FIG. 19 illustrates an example of a flow of a reservation accommodation process (S21-3) according to the present embodiment. On the basis of the “presence or absence of bottleneck (number of times)” 44-3, the reserved amount setting unit 16 determines whether or not the accommodation-possible resource management table 44 includes a business system in which a bottleneck is “present”. When the accommodation-possible resource management table 44 includes a business system in which a bottleneck is “present” (Yes in S21-3-1), the reserved amount setting unit 16 extracts the business system having the greatest number of times of occurrence of bottlenecks from among business systems that have not accommodated resources (S21-3-5).

On the basis of the “amount of accommodation-possible resource” 44-6 of the extracted business system, the reserved amount setting unit 16 reduces, from each VM of the extracted business system, the reserved amount of accommodation-possible resources for that VM. In this example, the reserved amount setting unit 16 obtains an amount of resources that can be accommodated from the “amount of accommodation-possible resource” 44-6 of the extracted business system. From the “CPU reserved amount” 41-7 and the “memory reserved amount” 41-8 corresponding to the extracted business system in the business system configuration table 41, the reserved amount setting unit reduces the obtained amount of resources that can be accommodated.

The reserved amount setting unit 16 determines whether or not the amount of resources to be used by a VM in a reservation period was able to be reduced from the resources of the extracted business system (S21-3-7). When the reduced amount of resources is smaller than the amount of resources to be used by a VM in a reservation period (No in S21-3-7), the process returns to S21-3-1.

When the reduced amount of resources is equal to or greater than the amount of resources to be used by a VM in a reservation period (Yes in S21-3-7), the reserved amount setting unit 16 updates the corresponding reserved amount of resources in the business system configuration table 41 by the amount of resources reduced above (S21-3-8).

When the accommodation-possible resource management table 44 does not include a business system in which a bottleneck is “present” among business systems that were not extracted in S21-3-5 (No in S21-3-1), the reserved amount setting unit 16 performs the following process. Specifically, the reserved amount setting unit 16 refers to the accommodation-possible resource management table 44 and determines whether or not there is a business system having an amount of resources that can be accommodated from among business systems in which the occurrence of bottlenecks is “absent”.

When there is a business system having an amount of resources that can be accommodated among business systems in which the occurrence of bottlenecks is “absent” (Yes in S21-3-2), the reserved amount setting unit 16 performs the following process. Specifically, the reserved amount setting unit 16 selects the largest amount of accommodation-possible resources from among business systems in which the occurrence of bottlenecks is “absent”, on the basis of the accommodation-possible resource management table 44, and performs the process in S21-3-6.

When there are no business systems having an amount of resources that can be accommodated among business systems in which the occurrence of bottlenecks is “absent” (No in S21-3-2), the reserved amount setting unit 16 reports failure in the securement of resources to the administrator. Specifically, when none of the business systems had resources to be accommodated and it was not possible to reserve resources, the situation is one in which the amount of physical resources is insufficient, and accordingly the reserved amount setting unit 16 reports failure in reserving resources to the system administrator.

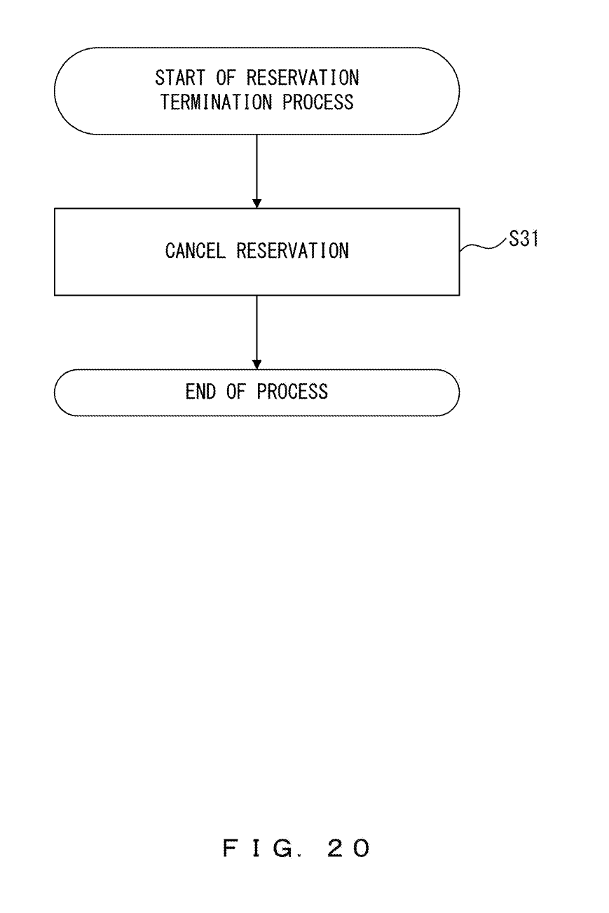

FIG. 20 illustrates an example of a reservation termination process flow executed by a reservation scheduler unit according to the present embodiment.

When the reservation scheduler unit 15 refers to the reservation schedule table 43 and compares the current time and the reservation ending time so as to determine that the reservation period has ended, the reservation scheduler unit 15 requests that the integration control device 21 cancel the setting of the reservation for the corresponding VM (S31). On the basis of that request, the integration control device 21 cancels the setting of the reservation for the corresponding VM.

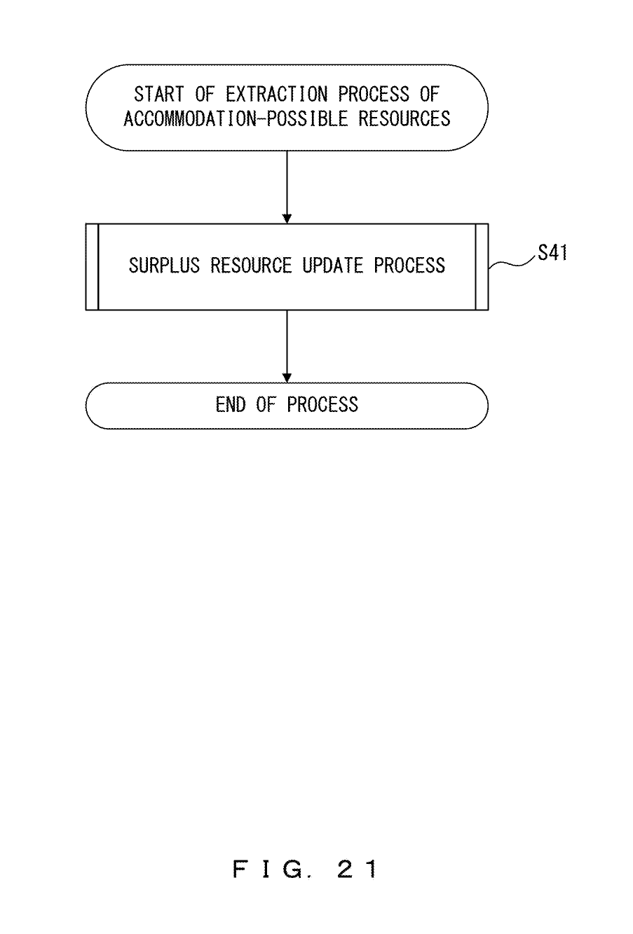

FIG. 21 illustrates an example of an accommodation-possible resource extraction process flow that is executed by a resource extraction unit according to the present embodiment. An accommodation-possible resource extraction process is started when the deterioration of a response of a business system is reported by the monitoring device 20.

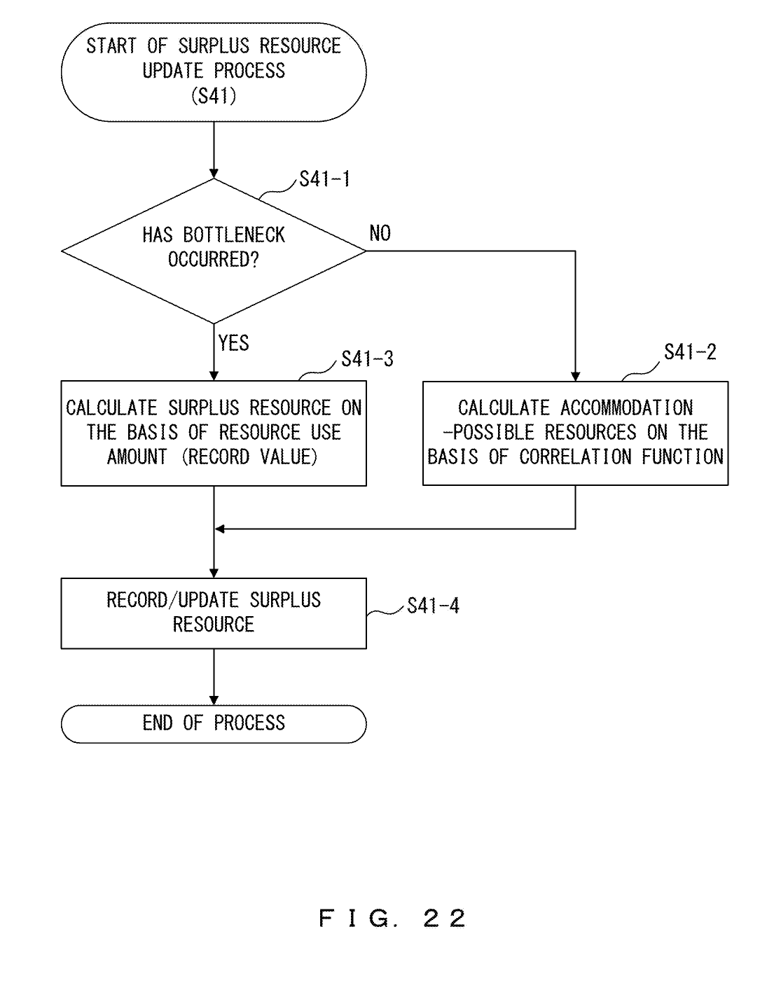

The resource extraction unit 17 performs a surplus resource update process (S41). In a surplus resource update process, the resource extraction unit 17 switches an extraction process of the amount of resources that can be accommodated on the basis of the presence or absence of the occurrence of bottlenecks, and registers or updates a value in the accommodation-possible resource management table 44. The process in S41 will be explained in detail in FIG. 22.

FIG. 22 illustrates an example of a process flow of a surplus resource update process according to the present embodiment (S41). When the deterioration of a response of a business system is reported by the monitoring device 20, the resource extraction unit 17 performs the following process. Specifically, on the basis of the resource use amount (record value) or the amount of requests (record value) of that business system collected by the accumulation device 19, the resource extraction unit 17 determines whether or not a bottleneck has occurred in that business system (S41-1).

In S41-1, the resource extraction unit 17 obtains from the business system configuration table 41 the amount of resources (“CPU” 41-5 and “memory” 41-6) allocated to a VM used by a business system for which the deterioration of a response was reported.

Then, the resource extraction unit 17 determines whether or not there is a resource whose resource use amount of that business system collected by the accumulation device 19 has reached the amount of allocated resources.

When there is a resource whose resource use amount has reached the amount of allocated resources, i.e., when a bottleneck has occurred (Yes in S41-1), the resource extraction unit 17 performs the following process. Specifically, on the basis of the resource use amount (record value), the resource extraction unit 17 calculates the free space of resources of each VM. The resource extraction unit 17 registers in the accommodation-possible resource management table 44 the calculated free space of resources as the amount of resources that can be accommodated (S41-4).

In this example, the amount of free resources in each VM is calculated by (amount of allocated resources-resource use amount (record value)). In the case of a VM in which a bottleneck has occurred (resource of a bottleneck), the amount of free resources of the VM is zero.

In the accommodation-possible resource management table 44, the resource extraction unit 17 adds a flag of a white circle representing a bottleneck to a resource of bottleneck. Then, the resource extraction unit 17 registers the occurrence time and date, registers “present” regarding the occurrence of a bottleneck, and adds one to the number of times of occurrence in the accommodation-possible resource management table 44.

In S41-1, when there are no resources whose resource use amount has reached the amount of allocated resources, i.e., when a bottleneck has not occurred (No in S41-1), the resource extraction unit 17 performs the following process. Specifically, the resource extraction unit 17 calculates the resource the will peak first, on the basis of a correlation analysis between the number of requests and the resource use amount in a unit time (S41-2). The resource extraction unit 17 registers in the accommodation-possible resource management table 44 the resource to peak first as a resource of a bottleneck (S41-4). Regarding other resources, the resource extraction unit 17 obtains the resource use amount from the number of requests in the same unit time, and registers free resources as accommodation-possible resources in the accommodation-possible resource management table 44. Also, the resource extraction unit 17 considers the occurrence of a bottleneck to be “absent”, and registers it in the accommodation-possible resource management table 44.

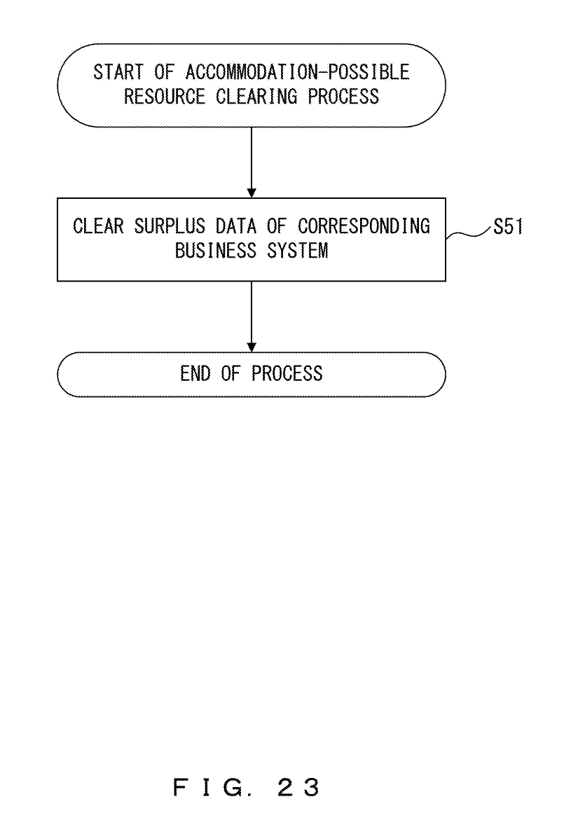

FIG. 23 illustrates an example of an accommodation-possible resource clearing process executed by a resource extraction unit according to the present embodiment.

When a change occurred to a configuration of a VM in a business system, the resource extraction unit 17 clears the amounts of accommodation-possible resources of all VMs, registered in the accommodation-possible resource management table 44 and used by that business system (S51).

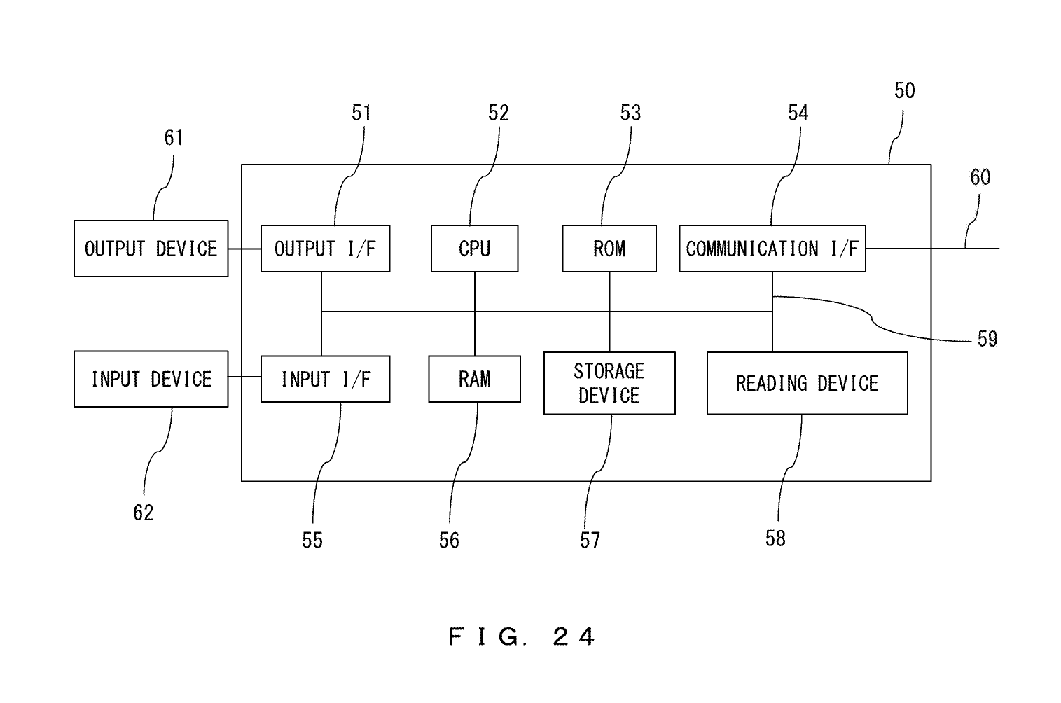

FIG. 24 is an example of a configuration block diagram of a hardware configuration of a computer that executes the programs according to the present embodiment. A computer 50 functions as the accommodation control device 13. The computer 50 includes a CPU 52, a ROM 53, a RAM 56, a communication I/F 54, a storage device 57, an output I/F 51, an input I/F 55, a reading device 58, a bus 59, an output device 61 and an input device 62.

In the above, a CPU refers to a central processing unit. The CPU may be for example a processor. A ROM refers to a read only memory. A RAM refers to a random access memory. An I/F refers to an interface. To the bus 59, the CPU 52, the ROM 53, the RAM 56, the communication I/F 54, the storage device 57, the output I/F 51, the input I/F 55 and the reading device 58 are connected. The reading device 58 is a device that reads information from a portable recording medium. The output device 61 is connected to the output I/F 51. The input device 62 is connected to the input I/F 55.

The storage device 57 corresponds to the storage unit 18, and a storage device of various types such as a hard disk, a flash memory, a magnetic disk, etc. can be used for it. The programs according to the present embodiment that make the CPU 52 function as the obtainment unit 2, the determination unit 3, the identification unit 4 and the provision unit 5 are stored in the storage device 57 or the ROM 53. More specifically, the programs according to the present embodiment that make the CPU function as the period detection unit 14, the reservation scheduler unit 15, the reserved amount setting unit 16 and the resource extraction unit 17 are stored in the storage device 57 or the ROM 53. Also, the business system configuration table 41, the virtual host table 42, the reservation schedule table 43 and the accommodation-possible resource management table 44 may be stored in the storage device 57.

The RAM 56 stores information temporarily. The RAM corresponds to a memory 30 according to the present embodiment.

The CPU 52 reads a program according to the present embodiment from the storage device 57 or the ROM: 53 and executes the program.

The communication I/F 54 is an interface, such as a port etc., for realizing communications with other devices by being connected to a network.

The programs that realize the processes explained in the above embodiments may be stored in for example the storage device 57 via the communication network 60 and the communication I/F 54 by a program provider side. Also, the programs that realize the processes explained in the above embodiments may be stored in a commercially available portable storage medium. In such a case, that portable storage medium may be set in the reading device 58 and have its program read by the CPU 52 so that it is executed. As a portable storage medium, a storage medium of variable types such as a CD-ROM, a flexible disk, an optical disk, a magneto-optical disk, an IC card, a USB memory device, a semiconductor memory card, etc. can be used. The programs stored in a storage medium such as above is read by the reading device 58.

As the input device 62, a keyboard, a mouse, an electron camera, a web camera, a microphone, a scanner, a sensor, a tablet, a touch panel, etc. can be used. Also, as the output device 61, a display device, a printer, a speaker, etc. can be used.

The network 60 may be a communication network such as the Internet, a LAN, a WAN, a dedicated line, a wired network, a wireless network, etc.

The present embodiment makes it possible to operate simultaneously many businesses that are given priority, also making it possible to prevent business influence, due to the accommodation of resources, on accommodating business systems (process delay).

The present embodiment suppresses the occurrence of depletion of resources in an information processing system that provides resources when the resources are provided between information processing systems.

Note that the scope of the present invention is not limited to the above described embodiments, and can employ various configurations or embodiments without departing from the spirit of the present invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A resource management device comprising:
a processor configured to:
obtain a use amount of a plurality of resources allocated to a first information processing system when a response time has exceeded a threshold in the first information processing system among a plurality of information processing systems that operate on a plurality of virtual machines;
determine whether or not depletion has occurred in any of the resources in the first information processing system on the basis of the use amount of the plurality of resources;
identify a surplus resource, which is a resource other than the depleted resource, from among the plurality of resources on the basis of the use amount of the plurality of resources when it is determined that the excess of the response time over the threshold is due to the depletion in any of the resources; and
accommodate the surplus resource to a second information processing system among the plurality of information processing systems.

2. The resource management device according to claim 1, wherein
the processor identifies the surplus resource from among the plurality of resources on the basis of information related to a relationship between a process load and an amount of resources used in accordance with the process load when the depletion has not occurred in any of the resources in the first information processing system.

3. The resource management device according to claim 1, wherein
the processor identifies, as the surplus resource, a surplus of resources used by the plurality of virtual machines on which the first information processing system operates at a time of occurrence of the depletion in any of the resources when the depletion has occurred in any of the resources.

4. The resource management device according to one of claim 1, wherein
the processor obtains a use amount of a resource allocated to each of the plurality of virtual machines on which the first information processing system operates at a time when a process response time has exceeded a threshold in the first information processing system;
the processor calculates a surplus amount of a resource allocated to a virtual machine other than a virtual machine in which the use amount has reached an upper limit of the allocated resource, among the plurality of virtual machines on which the first information processing system operates; and
the processer accommodates the calculated surplus amount of resources to a second information processing system among the plurality of information processing systems.

5. The resource management device according to claim 4, wherein
the processor calculates a surplus amount of a resource allocated to a virtual machine other than a virtual machine in which the use amount has reached an upper limit of the allocated resource among the plurality of virtual machines on which the first information processing system operates, on the basis of information related to a relationship between a process load and an amount of resources used in accordance with the process load when there has not been a virtual machine in which the use amount has reached an upper limit of the allocated resource among the plurality of virtual machines on which the first information processing system operates.

6. A non-transitory computer-readable recording medium having stored therein a resource management program that causes a computer to execute a process comprising:
obtaining a use amount of a plurality of resources allocated to a first information processing system when a response time has exceeded a threshold in the first information processing system among a plurality of information processing systems that operate on a plurality of virtual machines;
determining whether or not depletion has occurred in any of the resources in the first information processing system on the basis of the use amount of the plurality of resources;
identifying a surplus resource, which is a resource other than the depleted resource, from among the plurality of resources on the basis of the use amount of the plurality of resources when it is determined that the excess of the response time over the threshold is due to the depletion in any of the resources; and
accommodating the surplus resource to a second information processing system among the plurality of information processing systems.

7. The non-transitory computer-readable recording medium according to claim 6, wherein
the identifying of the surplus resource identifies the surplus resource from among the plurality of resources on the basis of information related to a relationship between a process load and an amount of resources used in accordance with the process load when the depletion has not occurred in any of the resources in the first information processing system.

8. The non-transitory computer-readable recording medium according to claim 6, wherein
the identifying of the surplus resource identifies, as the surplus resource, a surplus of resources used by the plurality of virtual machines on which the first information processing system operates at a time of occurrence of the depletion in any of the resources when the depletion has occurred in any of the resources.

9. The non-transitory computer-readable recording medium according to one of claim 6, wherein
the obtaining of a use amount of the plurality of resources obtains a use amount of a resource allocated to each of the plurality of virtual machines on which the first information processing system operates at a time when a process response time has exceeded a threshold in the first information processing system;
the identifying of the surplus resource calculates a surplus amount of a resource allocated to a virtual machine other than a virtual machine in which the use amount has reached an upper limit of the allocated resource, among the plurality of virtual machines on which the first information processing system operates; and
the accommodating of the surplus resource accommodates the calculated surplus amount of resources to a second information processing system among the plurality of information processing systems.

10. The non-transitory computer-readable recording medium according to claim 9, wherein
the identifying of the surplus resource calculates a surplus amount of a resource allocated to a virtual machine other than a virtual machine in which the use amount has reached an upper limit of the allocated resource among the plurality of virtual machines on which the first information processing system operates, on the basis of information related to a relationship between a process load and an amount of resources used in accordance with the process load when there has not been a virtual machine in which the use amount has reached an upper limit of the allocated resource among the plurality of virtual machines on which the first information processing system operates.

11. A resource management method comprising:
obtaining, by using a processor, a use amount of a plurality of resources allocated to a first information processing system when a response time has exceeded a threshold in the first information processing system among a plurality of information processing systems that operate on a plurality of virtual machines;
determining, by using the processor, whether or not depletion has occurred in any of the resources in the first information processing system on the basis of the use amount of the plurality of resources;
identifying, by using the processor, a surplus resource, which is a resource other than the depleted resource, from among the plurality of resources on the basis of the use amount of the plurality of resources when it is determined that the excess of the response time over the threshold is due to the depletion in any of the resources; and
accommodating, by using the processor, the surplus resource to a second information processing system among the plurality of information processing systems.

12. The resource management method according to claim 11, wherein
the identifying of the surplus resource identifies the surplus resource from among the plurality of resources on the basis of information related to a relationship between a process load and an amount of resources used in accordance with the process load when the depletion has not occurred in any of the resources in the first information processing system.

13. The resource management method according to claim 11, wherein
the identifying of the surplus resource identifies, as the surplus resource, a surplus of resources used by the plurality of virtual machines on which the first information processing system operates at a time of occurrence of the depletion in any of the resources when the depletion has occurred in any of the resources.

14. The resource management method according to one of claim 11, wherein
the obtaining of a use amount of the plurality of resources obtains a use amount of a resource allocated to each of the plurality of virtual machines on which the first information processing system operates at a time when a process response time has exceeded a threshold in the first information processing system;
the identifying of the surplus resource calculates a surplus amount of a resource allocated to a virtual machine other than a virtual machine in which the use amount has reached an upper limit of the allocated resource, among the plurality of virtual machines on which the first information processing system operates; and
the accommodating of the surplus resource accommodates the calculated surplus amount of resources to a second information processing system among the plurality of information processing systems.

15. The resource management method according to claim 14, wherein
the identifying of the surplus resource calculates a surplus amount of a resource allocated to a virtual machine other than a virtual machine in which the use amount has reached an upper limit of the allocated resource among the plurality of virtual machines on which the first information processing system operates, on the basis of information related to a relationship between a process load and an amount of resources used in accordance with the process load when there has not been a virtual machine in which the use amount has reached an upper limit of the allocated resource among the plurality of virtual machines on which the first information processing system operates.
